(19) United States
(12) Patent Application Publication
(10) Pub. No.: US 2026/0276293 A1
(43) Pub. Date: Sep. 17, 2026

(54) DOOR BODY ASSEMBLY FOR EMBEDDED REFRIGERATION APPARATUS AND EMBEDDED REFRIGERATION APPARATUS

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventor: Zhanwei Liu, Hefei (CN)

(21) Appl. No.: 19/161,233

(22) PCT Filed: Nov. 19, 2024
(86) PCT No.: PCT/CN2024/133027

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411186937.2

(51) Int. Cl. F25D 23/02; F25D 23/10

(52) U.S. Cl. CPC F25D 23/028; F25D 23/10; F25D 2323/021; F25D 2323/024

(57) ABSTRACT

A side-by-side door body assembly for an embedded refrigeration apparatus includes a pair of box doors and a pair of door panels. The box doors are rotatably connected to a refrigeration body configured to be embedded in an accommodating space defined by a mounting body. Each door panel is movably mounted on a corresponding box door and is configured to move in the width direction of the box door. Each door panel comprises a first interference position and a second interference position. When the box doors are in the closed position, a gap δ is formed between the end faces of the door panels on the opening side, and a gap δ′ is formed between the hinge-side end face of each door panel and the corresponding side wall of the accommodating space. The gaps δ and δ′ are each greater than respective preset movement distances γ and λ before the interference positions exit the accommodating space.

### CROSS-REFERENCES TO RELATED APPLICATIONS

The present application claims priority to Chinese patent application No. 202323218961.3 filed on Nov. 27, 2023, entitled “Refrigerator Hinge”, to Chinese patent application No. 202410088590.1 filed on Jan. 22, 2024, entitled “Door Body Assembly and Refrigeration Apparatus”, and to Chinese patent application No. 202411186937.2 filed on Aug. 26, 2024, entitled “Door Body Assembly for Embedded Refrigeration Apparatus and Embedded Refrigeration Apparatus”, which are hereby incorporated by reference in their entireties.

### FIELD

The present application relates to the field of refrigeration, and in particular to a door assembly for an embedded refrigeration apparatus and an embedded refrigeration apparatus.

### BACKGROUND

In modern society, rapid advancement of science and technology has greatly promoted changes in home lifestyles. Embedded furniture, as a design concept that combines aesthetics and practicality, has gained popularity among consumers. Embedded furniture cleverly integrates appliances or a storage space into the home, effectively saving space and significantly enhancing the overall harmony and aesthetics of the home. An embedded refrigerator, as an example, is allowed to be seamlessly embedded into the cupboard, blending perfectly with the kitchen's decoration style and creating a modern and harmonious living environment. However, despite the significant advantages of embedded refrigerators in enhancing home aesthetics and space utilization, they still present a significant practical issue: box doors can easily interfere with or collide with sidewalls of the cupboard during opening, resulting in a poor user experience.

### BRIEF SUMMARY

The present application provides a door body assembly for a refrigeration apparatus, which can solve a problem that the door body assembly interferes.

The present application further provides an embedded refrigeration apparatus.

The door body assembly for the refrigeration apparatus according to an embodiment of the present application includes:
a side-by-side box door, including two box doors provided in a pair, where the box doors are rotatably connected to a refrigeration box body, where the refrigeration box body is embedded into an accommodation space formed by a mount body;
a side-by-side door panel, including two door panels provided in a pair, where the door panels are movably mounted to the box doors and are movable along a width direction of the box doors, and the door panels are configured for moving toward a door-opening side during opening of the side-by-side box door,
each of the door panels has a first interference position and a second interference position, where the first interference position is located at an inner corner of the door panel on a door-opening side and the second interference position is located at an outer corner of the door panel on a hinge side;
when the side-by-side box door is in a closed position, a gap between end surfaces of the two door panels on the door-opening side is δ, and a distance between end surfaces of the door panels on the hinge side and a sidewall of the corresponding accommodation space is δ′; and
δ is greater than a movement distance γ along a width direction of the accommodation space before the first interference position moves away from the accommodation space, and δ′ is greater than a movement distance λ along the width direction of the accommodation space before the second interference position moves away from the accommodation space.

According to an embodiment of the present application, positions on the door panel where interference is most likely to occur are first determined as the first interference position and the second interference position, respectively, and the positions of the first interference position and the second interference position at the door panel are determined. On this basis, the conditions that must be met for the first interference position to not cause interference and the conditions that must be met for the second interference position to not cause interference are determined. Therefore, a relationship between the initial gaps (δ and δ′) of the side-by-side box door assembly and the movement of the door panels is determined to ensure normal operation of the embedded refrigeration apparatus.

According to an embodiment of the present application, the side-by-side box door includes a first box door and a second box door, both of the first box door and the second box door are rotatably connected to the refrigeration box body. The side-by-side door panel include a first door panel and a second door panel, where the first door panel is movably mounted to the first box door, and the second door panel is movably mounted to the second box door;
a movement distance along a width direction of the accommodation space before a first interference position of the first door panel moves away from the accommodation space is γ1, and a movement distance along the width direction of the accommodation space before a first interference position of the second door panel moves away from the accommodation space is γ2,
the first box door and the second box door are opened simultaneously, with γ1+γ2≤δ, or
one of the first box door or the second box door is opened, with γ1≤δ and γ2≤δ.

According to an embodiment of the present application, a movement distance along a width direction of the accommodation space before a second interference position of the first door panel moves away from the accommodation space is λ1, and a movement distance along the width direction of the accommodation space before a second interference position of the second door panel moves away from the accommodation space is λ2;
a gap between an end surface of the first door panel on a hinge side and a sidewall of the corresponding accommodation space is δ3, and a gap between an end surface of the second door panel on a hinge side and a sidewall of the corresponding accommodation space is δ4;

$$λ1 ⩽ δ3 ; λ2 ⩽ δ4 .$$

According to an embodiment of the present application, δ is positively correlated with l1, l3, h1, l4, l5, h2, a maximum Δs1 before the first interference position of the first door panel moves away from the accommodation space, and a maximum Δs2 before the first interference position of the second door panel moves away from the accommodation space;
where l1 is a vertical distance from a hinge shaft center of the first box door to an inner surface of the first door panel, l3 is a vertical distance from the hinge shaft center of the first box door to the end surface of the first door panel on a hinge side, h1 is a thickness of the first door panel, Δs1 is a distance that the first door panel moves relative to the first box door during opening of the first box door;
where l4 is a vertical distance from a hinge shaft center of the second box door to an inner surface of the second door panel, l5 is a vertical distance from the hinge shaft center of the second box door to the end surface of the second door panel on a hinge side, h2 is a thickness of the second box panel, Δs2 is a distance that the second door panel moves relative to the second box door during opening of the second box door;

According to an embodiment of the present application, δ3 is positively correlated with l1, l3, and h1, and negatively correlated with a maximum Δs1 before the first interference position of the first door panel moves away from the accommodation space;
δ4 is positively correlated with l4, l5, and h2, and negatively correlated with a maximum Δs2 before the first interference position of the second door panel moves away from the accommodation space.

According to an embodiment of the present application,

$$δ 3 \geq λ 1 = b 1 * cos β1 - l 3 ,$$

$$where b 1 = \sqrt{{( l 1 + h 1 )}^{2} + {( l 3 - Δ s 1 )}^{2}} ,$$

$$β1 = 9 {0}^{∘} - [ arctan ( \frac{l 3 - Δ s 1}{l 1 + h 1} ) + Δθ1 ] ;$$

$$δ4 \geq λ 2 = b 2 * cos β 2 - l 5 ,$$

$$where b 2 = \sqrt{{( l 4 + h 2 )}^{2} + {( l 5 - Δ s 2 )}^{2}} ,$$

$$β2 = 9 {0}^{∘} - [ arctan ( \frac{l 5 - Δ s 2}{l 4 + h 2} ) + Δ θ2 ] ;$$

$$δ \geq γ1 + γ 2 = a 1 * cos α1 - l 2 + a 2 * cos α 2 - l 6 , or$$

$$δ \geq γ1 = a 1 * cos α1 - l 2 , and , δ \geq γ 2 = a 2 * cos α 2 - l 6 ,$$

$$where a 1 = \sqrt{l {1}^{2} + {( l 2 + Δ s 1 )}^{2}} , α 1 = 9 {0}^{∘} - [ arctan ( \frac{l 2 + Δ s 1}{l 1} ) - Δ θ 1 ]$$

$$a 2 = \sqrt{l {4}^{2} + {( l 6 + Δ s 2 )}^{2}} , α 2 = 9 {0}^{∘} - [ arctan ( \frac{l 6 + Δ s 2}{l 4} ) - Δ θ2 ] ;$$

Δθ1 is an opening angle of the first box door, Δs1 is a distance that the first door panel moves relative to the door-opening side of the first box door during the opening of the first box doo, l1 is the vertical distance from the hinge shaft center of the first box door to the inner surface of the first door panel, l2 is a vertical distance from the hinge shaft center of the first box door to the end surface of the first door panel on a door-opening side, l3 is the vertical distance from the hinge shaft center of the first box door to the end surface of the first door panel on a hinge side, h1 is the thickness of the first door panel, a1 is a length of a side where the first interference position and the hinge shaft center of the first box door are located, α1 is an angle between the side where the first interference position and the hinge shaft center of the first box door are located and a horizontal line, b1 is a length of a side where the second interference position and the hinge shaft center of the first box door are located, and β1 is an angle between the side where the second interference position and the hinge shaft center of the first box door are located and the horizontal line;
Δθ2 is an opening angle of the second box door, Δs2 is a distance that the second door panel moves relative to the door-opening side of the second box door during the opening of the second box door, l4 is the vertical distance from the hinge shaft center of the second box door to the inner surface of the second door panel, l6 is a vertical distance from the hinge shaft center of the second box door to the end surface of the second door panel on a door-opening side, l5 is a vertical distance from the hinge shaft center of the second box door to the end surface of the second door panel on the hinge side, h2 is the thickness of the second door panel, a2 is a length of a side where the first interference position and the hinge shaft center of the second box door are located, α2 is an angle between the side where the first interference position and the hinge shaft center of the second box door are located and a horizontal line, b2 is a length of a side where the second interference position and the hinge shaft center of the second box door are located, and β2 is an angle between the side where the second interference position and the hinge shaft center of the second box door are located and the horizontal line.

According to an embodiment of the present application, the gap δ satisfies the following:

$$δ ⩽ {γ}_{max} ;$$

where γₘₐₓ is a value of γ corresponding to a case where Δ is zero and Δθ is Δθ_{crit}, γ is a vertical distance that the first interference position moves toward the sidewall of the corresponding accommodation space, λ is a vertical distance that the second interference position moves toward the sidewall of the corresponding accommodation space, Δθ is an angle of rotation during opening of the box door, Δθ that the first interference position moves away from the accommodation space is Δθ_{crit}, γ is positively correlated with Δs, Δs is a distance that the door panel moves relative to the door-opening side of the door during opening.

According to an embodiment of the present application, the distance δ′ satisfies the following:

$${δ}^{′} ⩽ {λ}_{max} ;$$

where λₘₐₓ is a value of λ in a case that γ is zero and Δθ is Δθ_{crit}, λ is negatively correlated with Δs, γ is a vertical distance that the first interference position moves toward the sidewall of the corresponding accommodation space, λ is a vertical distance that the second interference position moves toward the sidewall of the corresponding accommodation space, Δθ is an angle of rotation during opening of the box door, Δθ that the first interference position moves away from the accommodation space is Δθ_{crit}, γ is positively correlated with Δs, Δs is a distance that the door panel moves relative to the door-opening side of the door during opening.

According to an embodiment of the present application, a hinge shaft center is a movable shaft.

According to an embodiment of the present application, l1 is 5 mm to 50 mm, l2 is 240 mm to 700 mm, l3 is (300 mm to 700 mm) minus l2, h1 is 10 mm to 25 mm, and δ3 is 0.5 mm to 5 mm;
l4 is 5 mm to 50 mm, l5 is 240 mm to 700 mm, l6 is (300 mm to 700 mm) minus 15, h2 is 10 mm to 25 mm, and δ4 is 0.5 mm to 5 mm.

According to an embodiment of the present application, l1 is 5 mm to 50 mm, l2 is 240 mm to 700 mm, l3 is (300 mm to 700 mm) minus l2, l4 is 5 mm to 50 mm, l5 is 240 mm to 700 mm, l6 is (300 mm to 700 mm) minus 15, h2 is 10 mm to 25 mm, and δ is 1 mm to 10 mm.

According to an embodiment of the present application, an embedded refrigeration apparatus includes:
a refrigeration box body embedded in an accommodation space; and
the door body assembly mentioned above.

Additional aspects and advantages of the present application are set forth in part in the description which follows and, in part, are apparent from the description, or may be learned by practice of the present application.

### BRIEF DESCRIPTION OF THE DRAWINGS

To more clearly illustrate solutions in the embodiments of the present application or the related art, the drawings that need to be used in the descriptions of the embodiments or the related art are briefly described below. The drawings in the following description are only certain embodiments of the present application, and for those skilled in the related art, other drawings may be obtained based on these drawings without any creative work.

FIG. 1 is a mounting schematic diagram of a door body assembly for an embedded refrigeration apparatus according to an embodiment of the present application;

FIG. 2 is a simplified schematic diagram of boundary conditions required for the door panel to not interfere with cupboard panels on either side during opening and closing according to an embodiment of the present application;

FIG. 3 is a partial enlarged schematic diagram of FIG. 2;

FIG. 4 is an exploded diagram of a refrigeration apparatus according to an embodiment of the present application;

FIG. 5 is a first schematic diagram of a slide door mechanism according to an embodiment of the present application;

FIG. 6 is a second schematic diagram of a slide door mechanism according to an embodiment of the present application;

FIG. 7 is an exploded diagram of a slide door mechanism according to an embodiment of the present application;

FIG. 8 is a schematic structural diagram of a slide door mechanism according to an embodiment of the present application;

FIG. 9 is a schematic structural diagram of a guide according to an embodiment of the present application;

FIG. 10 is a schematic structural diagram of a slide member according to an embodiment of the present application;

FIG. 11 is a first schematic structural diagram of a first driven guide rail mechanism according to an embodiment of the present application;

FIG. 12 is a second schematic structural diagram of a first driven guide rail mechanism according to an embodiment of the present application;

FIG. 13 is a first schematic structural diagram of a second driven guide rail mechanism according to an embodiment of the present application;

FIG. 14 is a second schematic structural diagram of a second driven guide rail mechanism according to an embodiment of the present application;

FIG. 15 is a schematic diagram of a door panel according to the embodiment of the present application;

FIG. 16 is a schematic diagram of a first hook and a second hook according to an embodiment of the present application;

FIG. 17 is a schematic diagram of a box door, a first end cover, and a second end cover according to an embodiment of the present application;

FIG. 18 is an assembly schematic diagram of a box door, a first end cover, a second end cover, a slide door mechanism, driven guide rail mechanisms, and hinges according to an embodiment of the present application;

FIG. 19 is a schematic diagram of a first end cover according to an embodiment of the present application;

FIG. 20 is a schematic diagram of a second end cover according to an embodiment of the present application;

FIG. 21 is a schematic diagram of a door panel when door panels need to be mounted according to the embodiment of the present application;

FIG. 22 is a schematic diagram of a door panel when no door panels need to be mounted according to the embodiment of the present application;

FIG. 23 is a first schematic diagram of a first primary decorative cover according to an embodiment of the present application;

FIG. 24 is a second schematic diagram of a first primary decorative cover according to an embodiment of the present application;

FIG. 25 is a schematic diagram of a first secondary decorative cover according to an embodiment of the present application;

FIG. 26 is a first schematic diagram of a second primary decorative cover according to an embodiment of the present application;

FIG. 27 is a second schematic diagram of a second primary decorative cover according to an embodiment of the present application;

FIG. 28 is a schematic diagram of a second secondary decorative cover according to an embodiment of the present application;

FIG. 29 is a schematic diagram of a third end cover according to an embodiment of the present application;

FIG. 30 is a schematic diagram of a fourth end cover according to an embodiment of the present application;

FIG. 31 is a first schematic diagram of a third primary decorative cover according to an embodiment of the present application;

FIG. 32 is a second schematic diagram of a third primary decorative cover according to an embodiment of the present application;

FIG. 33 is a schematic diagram of a third secondary decorative cover according to an embodiment of the present application;

FIG. 34 is a first schematic diagram of a fourth primary decorative cover according to an embodiment of the present application;

FIG. 35 is a second schematic diagram of a fourth primary decorative cover according to an embodiment of the present application; and

FIG. 36 is a schematic diagram of a fourth secondary decorative cover according to an embodiment of the present application.

### REFERENCE SIGNS

1: box body; 110: first connection hole; 120: first beam body; 121: second connection hole; 130: second beam body; 131: fourth connection hole; 132: third connection hole;
2: box door;
210: first end cover; 211: first hinge hole; 212: third mount slot; 213: first mount slot; 214: first avoidance opening; 215: second avoidance opening; 216: first mounting hole; 217: first protrusion ridge; 218: third recess; 219: fourth recess;
220: second end cover; 221: first guide rail fixation base; 223: second mounting hole; 224: third mounting hole; 225: second protrusion ridge; 227: third protrusion ridge;
310: third end cover; 311: second guide rail fixation base; 313: eighth protrusion ridge; 314: second hinge hole; 315: fourth mounting hole; 316: hand grip slot;
320: fourth end cover; 321: fourth avoidance opening; 322: third avoidance opening; 323: fifth mount slot; 324: sixth mount slot; 325: fifth mounting hole; 327: ninth protrusion ridge;
4: first hinge; 5: second hinge; 6: third hinge;
7: slide door mechanism; 701: first fixation base; 702: second fixation base; 703: second adjustment member; 704: first adjustment member; 705: first bearing; 706: flexible cable; 707: first rotary shaft fixation base; 708: pin; 709: traction rod; 710: second rotary shaft fixation base; 711: connector; 712: first connection block; 713: second slider; 714: first slider; 715: third bearing; 716: second bearing; 717: first pedestal;
730: guide; 731: guide structure; 732: fixation panel; 733: slide recess; 734: slide bushing; 7311: first limit slot; 7312: second limit slot;
740: slide member; 741: guide rod; 742: slide block; 743: first connection arm; 744: second connection arm; 745: slide contact;
760: drive rod; 770: elastic member;
750: link assembly; 751: first link; 752: second link; 753: first hinge shaft; 754: second hinge shaft; 755: third hinge shaft;
8: first driven guide rail mechanism; 801: third fixation base; 802: fourth fixation base; 803: fourth adjustment member; 804: third adjustment member; 812: second connection block; 813: third slider; 817: second pedestal;
9: second driven guide rail mechanism; 901: fifth fixation base; 902: third pedestal; 903: fourth slider; 904: sixth fixation base; 905: third connection block;
13: first primary decorative cover; 1301: fifth notch; 1302: fourth notch; 1303: first notch; 1304: second notch; 1305: first snap slot; 1306: second protrusion rib; 1307: first protrusion rib;
14: second primary decorative cover; 1401: third notch; 1403: fourth protrusion ridge; 1404: sixth protrusion ridge; 1405: second snap slot; 1406: third snap slot; 1407: seventh protrusion ridge; 1408: fifth protrusion ridge;
15: third primary decorative cover; 1501: sixth notch; 1503: fourth snap slot;
16: fourth primary decorative cover; 1601: seventh notch; 1602: eighth notch; 1603: tenth notch; 1604: ninth notch; 1605: sixth snap slot; 1606: fifth snap slot;
17: first secondary decorative cover; 18: second secondary primary decorative cover; 1801: handle portion; 19: third secondary decorative cover; 20: fourth secondary decorative cover;
21: door panel; 2111: first hook; 2112: second hook;
60: cupboard; 601: first cupboard panel; 602: second cupboard panel.

### DETAILED DESCRIPTION

Embodiments of the present application are further described in detail below with reference to the drawings and embodiments. The following embodiments are intended to illustrate the present application, but are not intended to limit the scope of the present application.

In the description of the embodiments of the present application, it should be noted that the orientation or positional relationships indicated by the terms such as “center”, “longitudinal”, “lateral”, “upper”, “lower”, “front”, “back”, “left”, “right”, “vertical”, “horizontal”, “top”, “bottom”, “inside”, and “outside”, are based on the orientation or positional relationship shown in the drawings, and are merely for the convenience of describing the embodiments of the present application and simplifying the description, rather than indicating or implying that the device or component stated must have a particular orientation, or be constructed and operated in a particular orientation, and thus cannot be understood as limitation to the embodiments of the present application. Furthermore, the terms “first”, “second”, “third” are only used for descriptive purposes and should not be construed as indicating or implying a relative importance.

In the description of embodiments of the present application, it should be noted that, unless otherwise explicitly specified and defined, the terms “connected to” and “connected” shall be understood broadly. For example, it may be either fixedly connected or detachably connected, or may be integratedly connected; it may be either mechanically connected, or electrically connected; it may be either directly connected, or indirectly connected through an intermediate medium. The specific meanings of the terms above in embodiments of the present application may be understood by those skilled in the art in accordance with specific conditions.

In the embodiments of the present application, unless otherwise clearly stated and defined, the first feature being located “on” or “under” the second feature means that the first feature is in direct contact with the second feature or the first feature is in contact with the second feature by an intermediate medium. In addition, the first feature is “on,” “above” and “over” the second feature can refer to that the first feature is directly above or obliquely above the second feature, or simply refer to that the level of the first feature is higher than that of the second feature. The first feature is “under”, “below” and “beneath” the second feature can refer to that the first feature is directly below or obliquely below the second feature, or simply refer to that the level of the first feature is lower than that of the second feature.

In the description of the present specification, description with reference to the terms “one embodiment,” “some embodiments,” “an example,” “specific example,” “some examples” and the like, refers to that specific features, structures, materials or characteristics described in combination with an embodiment or an example are included in at least one embodiment or example of the embodiments of the present application. In the present specification, the schematic expressions of the above terms are not necessarily directed to the same embodiment or example. Furthermore, the particular features, structures, materials or characteristics described may be combined in any suitable manner in any one or more embodiments or examples. In addition, those skilled in the art may combine the different embodiments or examples described in this specification, as well as the features of the different embodiments or examples, without conflicting each other.

In modern society, rapid advancement of science and technology has greatly promoted changes in home lifestyles. Embedded furniture, as a design concept that combines aesthetics and practicality, has gained popularity among consumers. Embedded furniture cleverly integrates appliances or a storage space into the home, effectively saving space and significantly enhancing the overall harmony and aesthetics of the home. An embedded refrigerator, as an example, is allowed to be seamlessly embedded into the cupboard, blending perfectly with the kitchen's decoration style and creating a modern and harmonious living environment. However, despite the significant advantages of embedded refrigerators in enhancing home aesthetics and space utilization, they still present a significant practical issue: box doors can easily interfere with or collide with sidewalls of the cupboard during opening, resulting in a poor user experience.

Specifically, in case that embedded refrigerators (referred simply to as refrigerators) meet different usage requirements of users for both fully embedded flush and fully embedded refrigerators at the same time, the connection between the box door body (referred to as the box door) and the cupboard door panel (referred to as the door panel) can cause the entire door assembly to become thicker, resulting in that after the refrigerator is pushed inside an accommodation space of a cupboard, a door body assembly interfere with the door during opening and closing, relying solely on the refrigerator's hinges with a single shaft or dual shafts, making it impossible to open and use the refrigerator properly. Therefore, the present application provides a door body assembly that allows relative sliding between the box door and the door panel. When the door body assembly is opened, the door panel slides toward the side where the door is opened (i.e., a door-opening side). During the box door opening, a hinge side maintains the thickness of the box door itself, which is consistent with a door opening scenario without a door panel. During the box door closing process, the door panel moves toward the hinge side to return to its pre-opening state, which can satisfy requirements that the refrigerator is mounted in an embedded manner in the case with or without a door panel.

For aesthetic reasons, the gap between door panels in a same row of cupboards is generally within a range of 0 mm to 5 mm. Therefore, when the door panels are initially opened, there is a probability that relatively sliding door panels may interfere with the cupboard panels on both sides. After the door panels are opened to a certain angle, there is also a probability that the hinge side of the door panels may interfere with the cupboard panels.

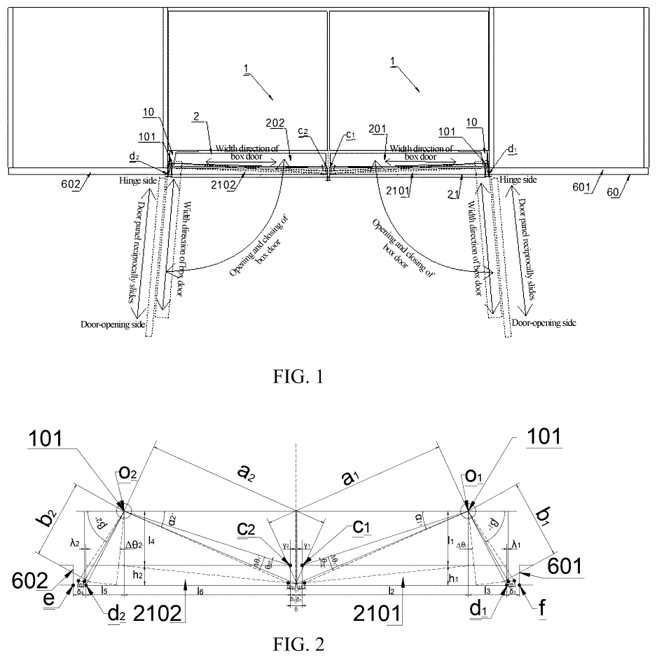

The present application provides a side-by-side door body assembly for an embedded refrigeration apparatus, including a side-by-side box door and a side-by-side door panel. Referring to FIG. 1 and FIG. 2, the side-by-side box door includes two box doors 2 provided in a pair, where the box doors 2 are rotatably connected to a refrigeration box body 1, where the refrigeration box body 1 is embedded into an accommodation space formed by a mount body. The mount body here generally refers to a cupboard 60. In an embodiment, the mount body can also be a corner of a wall, or the mount body can also refer to other components, as long as it can form an accommodating space. Description is made below by taking the mount body as the cupboard 60 as an example. The side-by-side door panel includes two door panels 21 provided in a pair, where the door panels 21 are movably mounted to the box doors 2 and are movable along a width direction of the box doors 2, and the door panels 21 are configured for moving toward a door-opening side during opening of the box door 2. Each of the door panels has a first interference position and a second interference position, where the first interference position is located at an inner corner of the door panel on a door-opening side, corresponding to c1 and c2 in FIG. 1 and FIG. 2, and the second interference position is located at an outer corner of the door panel on a hinge side, corresponding to d1 and d2 in FIG. 1 and FIG. 2. The “inner” and “outer” are relative to the refrigeration box body 1. The side facing the refrigeration box body 1 is the “inner” side, and the side facing away from the refrigeration box body 1 is the “outer” side. Since FIG. 2 is a top view, the first interference position and the second interference position are a point in FIG. 2. For the door panel 21, the first interference position and the second interference position are a vertical line, respectively. If the inner corner of the door-opening side is arc-shaped, the first interference position is a point on the arc-shaped segment farthest from a hinge shaft center 101 of the box door. Similarly, if the outer corner of the door panel on the hinge side is arc-shaped, the second interference position is the point on the arc-shaped segment farthest from the hinge shaft center 101 of the box door.

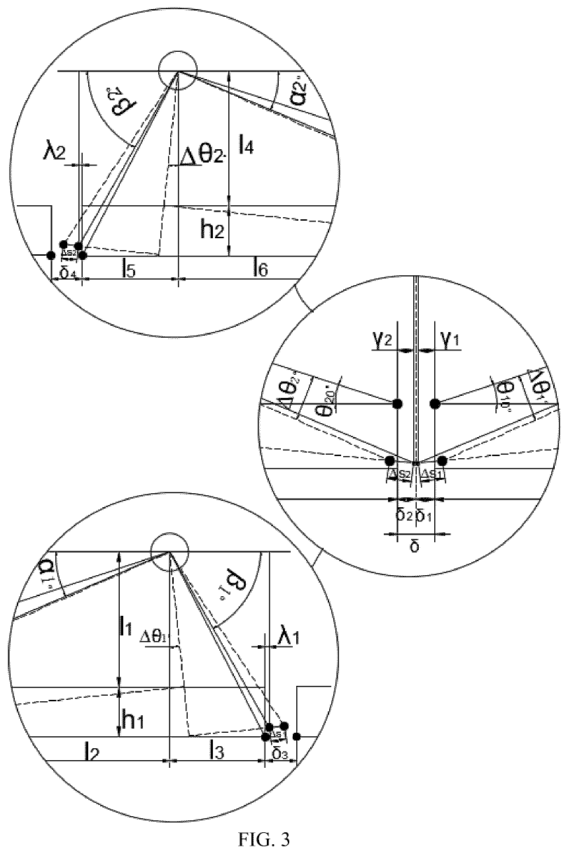

According to an embodiment of the present application, with reference to FIG. 2 and FIG. 3, when the side-by-side box door is in a closed position, a gap between end surfaces of the two door panels on the door-opening side is δ, and a distance between end surfaces of the door panels on the hinge side and a sidewall of the corresponding accommodation space is δ′; and δ is greater than a movement distance γ along a width direction of the accommodation space before the first interference position moves away from the accommodation space, and γ is a vertical distance that the first interference position moves toward a sidewall of the corresponding accommodation space. δ′ is greater than a movement distance λ along the width direction of the accommodation space before the second interference position moves away from the accommodation space, and λ is a vertical distance that the second interference position moves toward a sidewall of the corresponding accommodation space. When the box door is in the closed position, a width direction of the box door aligns with a width direction of the accommodation space. As the box door is opened, the width direction of the box door forms an angle with the width direction of the accommodation space.

According to an embodiment of the present application, positions at the door panel where interference is most likely to occur are first determined as the first interference position and the second interference position, respectively, and the positions of the first interference position and the second interference position on the door panel are determined. On this basis, the conditions that must be met for the first interference position to not cause interference and the conditions that must be met for the second interference position to not cause interference are determined. Therefore, a relationship between the initial gaps (δ and δ′) of the side-by-side box door assembly and the movement of the door panels is determined to ensure normal operation of the embedded refrigeration apparatus.

According to an embodiment of the present application, the side-by-side door body assembly includes at least two scenarios including a first scenario and a second scenario. In the first scenario, two single-door refrigeration apparatuses are placed into the same accommodation space, the two independent refrigeration apparatuses form a side-by-side door body assembly since door bodies are opposite. In the second scenario, a refrigeration apparatus has a side-by-side door body assembly. Considering the performance of the refrigeration apparatus, an initial gap δ between the two box doors may be known due to the dimensions of its vertical beams and the dimensions of the refrigeration compartment. Therefore, δ′ needs to be further determined.

According to an embodiment of the present application, the side-by-side box door includes a first box door 201 and a second box door 202, both of the first box door 201 and the second box door 202 are rotatably connected to the refrigeration box body 1. The side-by-side door panel include a first door panel 2101 and a second door panel 2102, where the first door panel 2101 is movably mounted to the first box door 201, and the second door panel 2102 is movably mounted to the second box door 202. A movement distance along a width direction of the accommodation space before a first interference position of the first door panel 2101 moves away from the accommodation space is γ1, and a movement distance along the width direction of the accommodation space before a first interference position of the second door panel 2102 moves away from the accommodation space is γ2. A gap between the first door panel 2101 and a centerline of the two door panels is δ1, and a gap between the second door panel 2102 and the centerline of the two door panels is δ2. It's worth noting that side-by-side door body assembly has a plurality of different usage scenarios. If the first box door 201 and the second box door 202 need to be opened simultaneously, the requirement for δ is relatively high: γ1+γ2≤δ. If the first box door 201 and the second box door 202 only need to be opened at different times, the requirement for δ is low, only satisfying: γ1≤δ and γ2≤δ, that is, δ is greater than or equal to the larger of γ1 and γ2.

According to an embodiment of the present application, a movement distance along a width direction of the accommodation space before a second interference position of the first door panel 2101 moves away from the accommodation space is λ1, and λ1 is also a vertical distance that the second interference position of the first door panel 2101 moves toward the sidewall of the corresponding accommodation space. A movement distance along the width direction of the accommodation space before a second interference position of the second door panel 2102 moves away from the accommodation space is λ2, and λ2 is also a vertical distance that the second interference position of the second door panel 2102 moves toward a sidewall of the corresponding accommodation space. A gap between an end surface of the first door panel 2101 on a hinge side and a sidewall of the corresponding accommodation space is δ3, and a gap between an end surface of the second door panel 2102 on a hinge side and a sidewall of the corresponding accommodation space is δ4. That is, the gap δ′ mentioned above includes δ3 and δ4. Here, λ1≤δ3; λ2≤δ4.

With reference to FIG. 2 and FIG. 3, the hinge shaft center 101 of the box door corresponds to points o1 and o2 in the figures. l1 is a vertical distance from a hinge shaft center 101 of the first box door 201 to an inner surface of the first door panel 2101, l2 is a vertical distance from the hinge shaft center 101 of the first box door 201 to an end surface of the first door panel 2101 on the door-opening side, l3 is a vertical distance from the hinge shaft center 101 of the first box door 201 to the end surface of the first door panel on a hinge side, h1 is a thickness of the first box panel 2101, Δs1 is a distance that the first door panel 2101 moves relative to the first box door 201 during opening of the first box door 201.

l4 is a vertical distance from a hinge shaft center 101 of the second box door 202 to an end surface of the second door panel 2102 on the door-opening side, l5 is a vertical distance from the hinge shaft center 101 of the second box door 202 to an end surface of the second door panel 2102 on the hinge side, l6 is a vertical distance from the hinge shaft center 101 of the second box door 202 to the end surface of the second door panel 2102 on the door-opening side, h2 is a thickness of the second box panel 2102, Δs2 is a distance that the second door panel 2102 moves relative to the second box door 202 during opening of the second box door 202.

According to the embodiments of the present application, it can be understood that as l1, l3, and h1 increase, the door-opening side of the first door panel 2101 is more likely to interfere. Similarly, as l4, l5, and h2 increase, the door-opening side of the second door panel 2102 is more likely to interfere. Therefore, δ is positively correlated with l1, l3, h1, l4, l5, and h2. Furthermore, before the first interference position of the first door panel 2101 moves away from the accommodation space, the greater the distance Δs1 that the first door panel 2101 moves relative to the first box door 201 is, the greater δ1 is, which prevents the first door panel 2101 from colliding with the second door panel 2102 during movement. Similarly, before the first interference position of the second door panel 2102 moves away from the accommodation space, the greater the distance Δs1 that the second door panel 2102 moves relative to the first box door 201 is, the greater δ2 is, which prevents the second door panel 2102 from colliding with the first door panel 2101 during movement. In other words, the maximum Δs1 of the first door panel 2101 before the first interference position moves away from the accommodation space is positively correlated with the maximum Δs2 of the second door panel 2102 before the first interference position moves away from the accommodation space, and both are positively correlated with δ.

According to the embodiments of the present application, the larger l1, l3, and h1 are, the more likely the hinged side of the door panel of the first box door 201 will interfere with the first cupboard panel 601. Therefore, δ3 needs to be designed to be larger. In other words, δ3 is positively correlated with l1, l3, and h1. Furthermore, the larger the maximum Δs1 before the first interference position of the first door panel 2101 moves away from the accommodation space, the smaller δ3 is required to ensure that the hinged side of the first door panel 2101 does not interfere with the cupboard panel. Therefore, δ3 is negatively correlated with the maximum Δs1 before the first interference position of the first door panel 2101 moves away from the accommodation space. Similarly, δ4 is positively correlated with l4, l5, and h2, and negatively correlated with a maximum Δs2 before the first interference position of the second door panel 2102 moves away from the accommodation space.

In FIG. 2 and FIG. 3, an initial position relationship (indicated by the dotted lines) and an angle relationship of the refrigeration apparatus (refrigerator) when the door is initially closed and when the door is opened to any angle are simplified and illustrated. Corners where interference may occur during the box door opening are marked with black dots. For the first door panel 2101, the first interference position, point c1, is likely to interfere with a point on the right side of the second door panel 2102 close to an outward side. That is, the point on the right side of the second door panel 2102 close to the outward side is a critical point at which point c1 escapes interference (moves away from the accommodation space) during the door opening and closing process. Similarly, for the second door panel 2102, the first interference position, point c2, is likely to interfere with a point on the left side of the first door panel 2101 close to an outward side. That is, the point on the left side of the first door panel 2101 close to the outward side is a critical point at which point c2 escapes interference (moves away from the accommodation space) during the door opening and closing process. For the first door panel 2101, its second interference position, point d1, is a corner point on a right side of the door panel close to an outward side and is the corner point where the right end surface of the door panel first interferes with a left end surface of the first cupboard panel 601 adjacent to the right side during the door opening and closing process. Similarly, for the second door panel 2102, its second interference position, point d2, is a corner point on a left side of the door panel close to an outward side and is the corner point where the right end surface of the door panel first interferes with a left end surface of the second cupboard panel 602 adjacent to the left side during the door opening and closing process.

As can be seen from FIG. 2 and FIG. 3, taking the first door panel 2101 as an example, in the initial position, on the left side of the hinge shaft center 101, an angle between the oblique line segment o1c1 where the point c1 and the hinge shaft center 101 are located and an inner side of the first door panel 2101 is θ10, and the angle when the box door is opened to any position is Δθ1. At this position, the oblique line segment o1c1, the distance l2 and the distance l1 are represented by dotted lines; in the initial position, on the right side of the hinge shaft center 101, an oblique line segment where the point d1 and the hinge shaft center 101 are located is o1d1, and the angle when the door is opened to any position is Δθ1. At this position, the oblique line segment o1d1, the distance l1+h1 and the distance l3 are represented by dotted lines; As can be seen from FIG. 2 and FIG. 3, if the first door panel 2101 does not move toward the door-opening side along the box door during the opening of the box door, as the opening angle increases, point d1 will quickly interfere with the left end surface of the first cupboard panel 601, resulting in that the first box door 201 fails to be opened. Therefore, to prevent this interference from affecting the door opening, the first door panel 2101 must be moved toward the door opening by a distance Δs1 when the door opening angle is Δθ1 during the door opening. It is assumed that after the first door panel 2101 has moved a distance Δs1, a length of the oblique line segment where the point c1 and the hinge shaft center 101 (i.e., o1) are located is set to a1, and an angle between the oblique line segment and the horizontal line in FIG. 3 is set to α1. A length of an oblique line segment where point d1 and o1 are located is set to b1, and the angle between the oblique line segment and the horizontal line in FIG. 3 is set to β1. A horizontal displacement of point c1 on a cupboard board 3 at this position is set to γ1, and a horizontal distance between point d1 on the cupboard board 3 at this position and the right end surface of the cupboard board 3 at the initial position is set to λ1.

Taking the second door panel 2102 as an example, in the initial position, on the right side of the hinge shaft center 101, an angle between the oblique line segment o2c2 where the point c2 and the hinge shaft center 101 are located and an inner side of the second door panel 2102 is θ20, and the angle when the box door is opened to any position is Δθ2. At this position, the oblique line segment o2c2, the distance l4 and the distance l6 are represented by dotted lines; in the initial position, on the left side of the hinge shaft center 101, an oblique line segment where the point d2 and the hinge shaft center 101 are located is o2d2, and the angle when the door is opened to any position is Δθ2. At this position, the oblique line segment o2d2, the distance l4+h2 and the distance 15 are represented by dotted lines. As can be seen from FIG. 2 and FIG. 3, if the second door panel 2102 does not move toward the door-opening side along the box door during the opening of the box door, as the opening angle increases, point d2 will quickly interfere with the right end surface of the second cupboard panel 602, resulting in that the second box door 202 fails to be opened. Therefore, to prevent this interference from affecting the door opening, the second door panel 2102 must be moved toward the door opening by a distance Δs2 when the door opening angle is Δθ2 during the door opening. It is assumed that after the second door panel 2102 has moved a distance Δs2, a length of the oblique line segment where the point c2 and the hinge shaft center 101 (i.e., o2) are located is set to a2, and an angle between the oblique line segment and the horizontal line in FIG. 3 is set to α2. A length of an oblique line segment where point d2 and o2 are located is set to b2, and the angle between the oblique line segment and the horizontal line in FIG. 3 is set to β2. A horizontal displacement of point c2 on a second door panel 2102 at this position is set to γ2, and a horizontal distance between point d2 on the second door panel 2102 at this position and the right end surface of the second door panel 2102 at the initial position is set to λ2.

In an embodiment,

$$δ 3 \geq λ 1 = b 1 * cos β 1 - l 3 ;$$

$$where b 1 = \sqrt{{( l 1 + h 1 )}^{2} + {( l 3 - Δ s 1 )}^{2}} ,$$

$$β1 = 9 {0}^{∘} - [ arctan ( \frac{l 3 - Δ s 1}{l 1 + h 1} ) + Δ θ 1 ] .$$

As previously mentioned, Δθ1 is the angle of rotation during door opening, and Δs1 is the distance the first door panel 2101 moves relative to the door-opening side of the first box door 201 during opening. Therefore, given l1, l3, and h1, the relationship between δ3 and Δs1 can be calculated.

In an embodiment,

$$δ 4 \geq λ 2 = b 2 * cos β2 - l 5 ,$$

$$where b 2 = \sqrt{{( l 4 + h 2 )}^{2} + {( l 5 - Δ s 2 )}^{2}} ,$$

$$β2 = 9 {0}^{∘} - [ arctan ( \frac{l 5 - Δ s 2}{l 4 + h 2} ) + Δ θ 2 ] .$$

Thus, given l4, l5, and h2, the relationship between δ4 and Δs2 can be calculated.

According to an embodiment of the present application, when the first box door 201 and the second box door 202 need to be opened simultaneously, the following applies:

$$δ \geq γ 1 + γ 2 = a 1 * cos α1 - l 2 + a 2 * cos α 2 - l 6.$$

When the first box door 201 and the second box door 202 only need to be able to be opened sequentially, then δ≥γ1=a1*cos α1-l2, and, δ≥γ2=a2*cos α2-l6.

According to an embodiment of the present application,

$$a 1 = \sqrt{l {1}^{2} + {( l 2 + Δ s 1 )}^{2}} ,$$

$$α 1 = 9 {0}^{∘} - [ arctan ( \frac{l 2 + Δ s 1}{l 1} ) - Δθ1 ] ;$$

$$a 2 = \sqrt{l {4}^{2} + {( l 6 + Δ s 2 )}^{2}} , α 2 = 9 {0}^{∘} - [ arctan ( \frac{l 6 + Δ s 2}{l 4} ) - Δ θ 2 ] .$$

Δθ1 is an opening angle of the first box door, Δs1 is a distance that the first door panel moves relative to the door-opening side of the first box door during the opening of the first box door, l1 is the vertical distance from the hinge shaft center of the first box door to the inner surface of the first door panel, l2 is a vertical distance from the hinge shaft center of the first box door to the end surface of the first door panel on a door-opening side, l3 is the vertical distance from the hinge shaft center of the first box door to the end surface of the first door panel on a hinge side, h1 is the thickness of the first door panel, a1 is a length of a side where the first interference position and the hinge shaft center of the first box door are located, α1 is an angle between the side where the first interference position and the hinge shaft center of the first box door are located and a horizontal line, b1 is a length of a side where the second interference position and the hinge shaft center of the first box door are located, and β1 is an angle between the side where the second interference position and the hinge shaft center of the first box door are located and the horizontal line.

Δθ2 is an opening angle of the second box door, Δs2 is a distance that the second door panel moves relative to the door-opening side of the second box door during the opening of the second box door, l4 is the vertical distance from the hinge shaft center of the second box door to the inner surface of the second door panel, l6 is a vertical distance from the hinge shaft center of the second box door to the end surface of the second door panel on a door-opening side, l5 is the vertical distance from the hinge shaft center of the second box door to the end surface of the second door panel on the hinge side, h2 is the thickness of the second door panel, a2 is a length of a side where the first interference position and the hinge shaft center of the second box door are located, α2 is an angle between the side where the first interference position and the hinge shaft center of the second box door are located and a horizontal line, b2 is a length of a side where the second interference position and the hinge shaft center of the second box door are located, and β2 is an angle between the side where the second interference position and the hinge shaft center of the second box door are located and the horizontal line.

According to an embodiment of the present application, when the first door panel 2101 and the second door panel 2102 have equal width, during the door opening and closing process, the horizontal displacements of the first door panel 2101 and the second door panel 2102 are preferably such that γ1≤δ1=δ/2 and γ2≤δ2=δ/2.

The above formulas for calculating δ, δ3, and δ4 do not limit δ, δ3, and δ4. For example, the above formulas may also include correction coefficients or parameters. Furthermore, the above formulas are based on a fixed hinge shaft center 101. If the box door (at least one of the first box door 201 and the second box door 202) is mounted using biaxial hinges or movable hinges, the hinge shaft center 101 will change as the box door is opened. Consequently, the formulas for calculating δ, δ3, and δ4 will also change accordingly, and a movement distance of the hinge shaft center 101 needs to be calculated. Additionally, if there is a mounting gap between the door panels and the box door, h1 in the above calculation formula is a distance between a slide surface of the first door panel 2101 and an outer surface of the first door panel 2101. h2 is a distance between a slide surface of the second door panel 2102 and an outer surface of the second door panel 2102. l1 is a distance between a hinge point of the first box door 201 and the slide surface of the first door panel 2101. l4 is a distance between a hinge point of the second box door 202 and the slide surface of the second door panel 2102.

According to an embodiment of the present application, under the premise of ensuring that the side-by-side door body assembly does not interfere with each other, and to ensure the aesthetics and safety of the embedded refrigeration apparatus, as mentioned above, the initial gap between the two door panels generally does not exceed 5 mm. For the side-by-side door body assembly, an embodiment of the present application further provides upper limits for δ and δ′.

The gap δ satisfies: δ≤γₘₐₓ.

γₘₐₓ is an upper limit for δ, corresponding λ is zero (i.e., λ1 and λ2 are zero), and Δθ is the value of γ corresponding to the critical value of Δθ_{crit}.

In this case, when λ is zero, δ3 and δ4 can be zero. This means that the initial gap between the hinge side of the door panel and the cupboard panel (first cupboard panel 601 or second cupboard panel 602) can be zero or as close to zero as possible. To ensure that the hinge side of the door panel does not interfere with the cupboard panel, γₘₐₓ of the corresponding door panel on the door-opening side is the maximum γₘₐₓ required, and thus δₘₐₓ does not need to exceed γₘₐₓ.

According to an embodiment of the present application, the gap δ′ satisfies the following: δ′≤λₘₐₓ.

λₘₐₓ is an upper limit for δ′, corresponding γ is zero (i.e., γ1 and γ2 are zero), and Δθ is the value of λ when Δθ_{crit} is critical.

According to an embodiment of the present application, during the mounting of the embedded refrigeration apparatus, δ and δ′ can be manually controlled. Limit members can further be respectively provided on the door opening and hinge sides of the embedded refrigeration apparatus to ensure that during mounting, the initial gap on the door-opening side is δ, and the initial gap between the hinge side of the door panel and the cupboard is δ′. In an embodiment, an auxiliary mounting tool having a dimension corresponding to the sizes of δ and δ′ may be provided. During mounting, the auxiliary mounting tool can be used to ensure that the initial gap between the door panel and the cupboard meets the above requirements.

According to an embodiment of the present application, the relative movement between the door panel and the cupboard door is determined by a slide mechanism or a traction mechanism that drives a slide mechanism. If the relative movement between the door panel and the cupboard door is determined by the slide mechanism, once the slide mechanism is determined, movement amounts Δs1 and Δs2 of the door panel are known. The range of values for δ and δ′ can then be determined from Δs1 and Δs2.

According to an embodiment of the present application, when δ (δ1 and δ2) and δ′ (δ3 and δ4) are known, the functional relationship between Δs1 and Δs2 can be determined from δ and δ′, and a slide mechanism or traction cupboard that meets the requirements can be obtained based on Δs1 and Δs2. Alternatively, if the width of the accommodation space is known and all other factors besides Δs1 and Δs2 are determined for the side-by-side door body assembly, the specific values of δ and δ′ can be obtained, and. As can be calculated based on these values. Furthermore, if the width of the accommodation space is known, the specific values of δ and δ′ can be determined. To ensure aesthetic and reliable mounting, δ1=δ3 and δ2=δ4. Therefore, δ and δ′ can be calculated, respectively, and. As can be calculated based on these values.

According to an embodiment of the present application, l1 is 5 mm to 50 mm, l2 is 240 mm to 700 mm, l3 is (300 mm to 700 mm) minus l2, h1 is 10 mm to 25 mm, and δ3 is 0.5 mm to 5 mm;

According to an embodiment of the present application, l1 is 5 mm to 50 mm, l2 is 240 mm to 700 mm, l3 is (300 mm to 700 mm) minus l2, h1 is 10 mm to 25 mm, and δ3 is 0.5 mm to 5 mm;

According to an embodiment of the present application, l1 is 5 mm to 50 mm, l2 is 240 mm to 700 mm, l3 is (300 mm to 700 mm) minus l2, l4 is 5 mm to 50 mm, l5 is 240 mm to 700 mm, l6 is (300 mm to 700 mm) minus l5, h2 is 10 mm to 25 mm, and δ is 1 mm to 10 mm.

According to an embodiment of the present application, a vertical distance from the hinge shaft center of the door to the inner surface of the door panel is l1, a vertical distance from the hinge shaft center of the door to the end surface of the door panel on the door-opening side is l2, and a vertical distance from the hinge shaft center of the door to the end surface of the door panel on the hinge side is l3. The thickness of the door panel is h, where l1 is 5 mm to 50 mm, l2 is 240 mm to 700 mm, and l3 is (300 mm to 700 mm) minus l2, and h1 is 10 mm to 25 mm. In this case, the obtained door body assembly has an appropriate overall size, easily ensures the confidentiality of the refrigeration apparatus, and prevents interference with the door body assembly. Common values for l2 include 597 mm, 600 mm, 747 mm, 750 mm, 607 mm, and 610 mm. Common values for h include 16 mm, 18 mm, 20 mm, 22 mm, and 25 mm.

The movement distance Δs does not change by more than 3 mm for every 0.5° increase in the door opening angle of the door body assembly according to an embodiment of the present application. This ensures that the door panel moves as evenly as possible, preventing sudden, large-angle movement of the door panels. This in turn makes the door panel as discreet as possible and prevents users from panicking about the movement of the door panel.

According to an embodiment of the present application, the movement distance Δs does not exceed 5 mm before the first interference position moves away from the accommodation space. For example, the angle corresponding to the first interference position leaving the accommodation space is 2° to 5°. Because Δs is relatively small during this process, interference between the door panel and the accommodation space may be avoided.

In an embodiment, when the door opening angle Δθ of the door body assembly is 0.5°, the movement distance Δs is between 0.3 mm and 0.5 mm, and the movement distance Δs does not change by more than 3 mm for every 0.5° increase in the door opening angle of the door body assembly.

According to an embodiment of the present application, the relevant parameters during the box door opening of the door body assembly can be referred to in the following table.

TABLE 1
a gap between a left end surface of the door panel and an adjacent door panel
on the left side is δ1: γ ≤ δ1; a gap between a right end
surface of the door panel and an adjacent door panel on the right side is
δ2: λ ≤ δ2; a value range of δ1 and δ2 for single
door is 0.5 mm to 6 mm, and a value range of δ1 and δ2 for side-by-
side door is half of a gap between the two door panels, 0.5 mm to 5 mm

| l1 | l2 | l3 | h | θ0 | Δθ | α | β | Δs | γ | λ |
|---|---|---|---|---|---|---|---|---|---|---|
| 19.84 | 582.2 | 14.8 | 23 | 1.95175 | 0.5 | 2.45034 | 70.945 | 0.42 | 0.2247 | −0.0467 |
| 21.34 | 582.2 | 14.8 | 23 | 2.09918 | 1 | 3.09631 | 71.477 | 0.8 | 0.3388 | −0.02829 |
| 19.84 | 582.2 | 14.8 | 23 | 1.95175 | 1.5 | 3.44874 | 70.524 | 0.9 | 0.1808 | 0.216657 |
| 19.84 | 582.2 | 14.8 | 23 | 1.95175 | 2 | 3.94774 | 70.387 | 1.2 | 0.1522 | 0.28681 |
| 19.84 | 582.2 | 14.8 | 23 | 1.95175 | 2.5 | 4.44674 | 70.253 | 1.5 | 0.079 | 0.355996 |
| 19.84 | 582.2 | 14.8 | 23 | 1.95175 | 3 | 4.94574 | 70.119 | 1.8 | −0.039 | 0.424256 |
| 19.84 | 582.2 | 14.8 | 23 | 1.95175 | 3.5 | 5.44474 | 69.987 | 2.1 | −0.201 | 0.491631 |
| 19.84 | 582.2 | 14.8 | 23 | 1.95175 | 4 | 5.94374 | 69.857 | 2.4 | −0.408 | 0.558162 |
| 19.84 | 582.2 | 14.8 | 23 | 1.95175 | 4.5 | 6.44275 | 69.728 | 2.7 | −0.66 | 0.623887 |
| 19.84 | 582.2 | 14.8 | 23 | 1.95175 | 5 | 6.94175 | 69.6 | 3 | −0.956 | 0.688849 |
| 19.84 | 582.2 | 14.8 | 23 | 1.95175 | 5.5 | 7.44076 | 69.474 | 3.3 | −1.297 | 0.753088 |
| 19.84 | 582.2 | 14.8 | 23 | 1.95175 | 6 | 7.93976 | 69.349 | 3.6 | −1.683 | 0.816645 |
| 19.84 | 582.2 | 14.8 | 23 | 1.95175 | 6.5 | 8.43877 | 69.225 | 3.9 | −2.113 | 0.879559 |
| 19.84 | 582.2 | 14.8 | 23 | 1.95175 | 7 | 8.93778 | 69.102 | 4.2 | −2.589 | 0.941872 |
| 19.84 | 582.2 | 14.8 | 23 | 1.95175 | 7.5 | 9.43679 | 68.981 | 4.5 | −3.109 | 1.003624 |
| 19.84 | 582.2 | 14.8 | 23 | 1.95175 | 8 | 9.9358 | 68.861 | 4.8 | −3.674 | 1.064856 |
| 19.84 | 582.2 | 14.8 | 23 | 1.95175 | 8.5 | 10.4348 | 68.742 | 5.1 | −4.284 | 1.125609 |
| 19.84 | 582.2 | 14.8 | 23 | 1.95175 | 9 | 10.9338 | 68.624 | 5.4 | −4.938 | 1.185923 |
| 19.84 | 582.2 | 14.8 | 23 | 1.95175 | 9.5 | 11.4328 | 68.508 | 5.7 | −5.637 | 1.245838 |
| 19.84 | 582.2 | 14.8 | 23 | 1.95175 | 10 | 11.9319 | 68.392 | 6 | −6.381 | 1.305396 |
| 19.84 | 582.2 | 14.8 | 23 | 1.95175 | 10.5 | 12.4309 | 68.278 | 6.3 | −7.17 | 1.364637 |
| 19.84 | 582.2 | 14.8 | 23 | 1.95175 | 11 | 12.9299 | 68.164 | 6.6 | −8.004 | 1.4236 |
| 19.84 | 582.2 | 14.8 | 23 | 1.95175 | 11.5 | 13.4289 | 68.052 | 6.9 | −8.882 | 1.482327 |
| 19.84 | 582.2 | 14.8 | 23 | 1.95175 | 12 | 13.9279 | 67.94 | 7.2 | −9.805 | 1.540859 |
| 19.84 | 582.2 | 14.8 | 23 | 1.95175 | 12.5 | 14.4269 | 67.83 | 7.5 | −10.77 | 1.599234 |
| 19.84 | 582.2 | 14.8 | 23 | 1.95175 | 13 | 14.926 | 67.72 | 7.8 | −11.78 | 1.657494 |
| 19.84 | 582.2 | 14.8 | 23 | 1.95175 | 13.5 | 15.425 | 67.611 | 8.1 | −12.84 | 1.715678 |
| 19.84 | 582.2 | 14.8 | 23 | 1.95175 | 14 | 15.924 | 67.503 | 8.4 | −13.94 | 1.773827 |
| 19.84 | 582.2 | 14.8 | 23 | 1.95175 | 14.5 | 16.423 | 67.396 | 8.7 | −15.09 | 1.83198 |
| 19.84 | 582.2 | 14.8 | 23 | 1.95175 | 15 | 16.9221 | 67.29 | 9 | −16.28 | 1.890178 |
| 19.84 | 582.2 | 14.8 | 23 | 1.95175 | 15.5 | 17.4211 | 67.184 | 9.3 | −17.51 | 1.94846 |
| 19.84 | 582.2 | 14.8 | 23 | 1.95175 | 16 | 17.9201 | 67.079 | 9.6 | −18.79 | 2.006865 |
| 19.84 | 582.2 | 14.8 | 23 | 1.95175 | 16.5 | 18.4191 | 66.975 | 9.9 | −20.12 | 2.065434 |
| 19.84 | 582.2 | 14.8 | 23 | 1.95175 | 17 | 18.9182 | 66.871 | 10.2 | −21.49 | 2.124206 |
| 19.84 | 582.2 | 14.8 | 23 | 1.95175 | 17.5 | 19.4172 | 66.768 | 10.5 | −22.9 | 2.183219 |
| 19.84 | 582.2 | 14.8 | 23 | 1.95175 | 18 | 19.9162 | 66.666 | 10.8 | −24.35 | 2.242514 |
| 19.84 | 582.2 | 14.8 | 23 | 1.95175 | 18.5 | 20.4092 | 69.094 | 13 | −24.05 | 0.500314 |
| 19.84 | 582.2 | 14.8 | 23 | 1.95175 | 19 | 20.9028 | 71.267 | 15 | −24 | −1.04176 |

According to an embodiment of the present application, when the dimensions of the door body assembly are limited to those in Table 1 above, γ is between −24 mm and 0.4 mm, λ is between −1 mm and 2.2 mm, and γ≤δ1 and λ≤δ2.

According to an embodiment of the present application, when the dimensions of the door body assembly are limited to those in Table 1 above, during the opening of the door panel assembly, an angle between a line connecting the first interference position and the hinge shaft center of the box door and the horizontal position is set to α, and an angle between a line connecting the second interference position and the hinge shaft center of the box door and the horizontal position is set to β. The angle α is between 2.4° and 21°, and the angle β is between 66° and 72°.

According to an embodiment of the present application, the slide door mechanism 7 includes a slide mechanism and a traction mechanism.

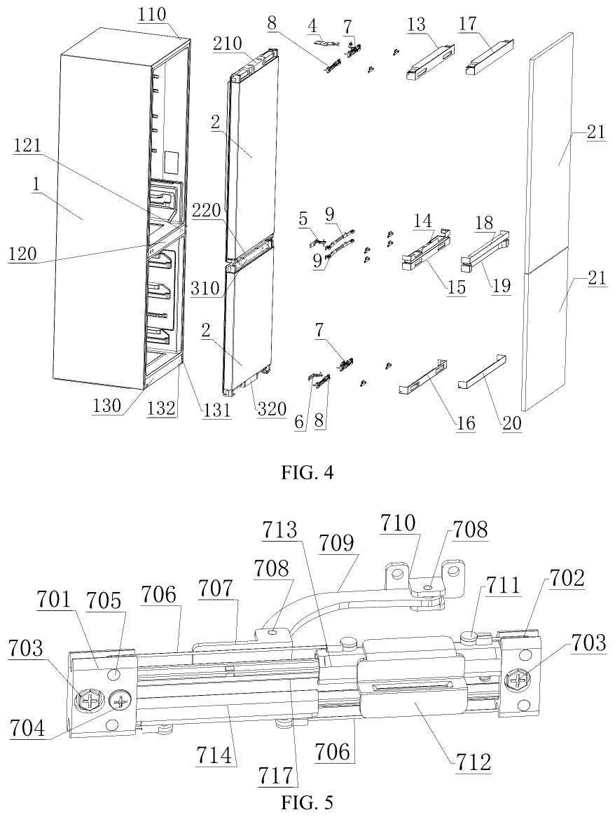

According to an embodiment of the present application, as shown in FIG. 4 and FIG. 5, the slide mechanism includes: a first pedestal 717, a first slider 714, a second slider 713, and a flexible cable 706. One side of the first pedestal 717 is formed with a first guide rail and another side of the first pedestal 717 is formed with a second guide rail. The first slider 714 is slidably provided at the first guide rail, and the traction mechanism is rotatably connected between the box body 1 and the first slider 717. The second slider 713 is slidably provided at the second guide rail and is used for connecting with the door panel 21. Two ends of the flexible cable 706 are connected to the first slider 714 and the second slider 713, respectively. In the case that the first slider 714 moves on the first guide rail, the first slider 714 drives the second slider 713 in the opposite direction at the second guide rail through the flexible cable 706 to drive the door panel 21 relative to a width direction of the box door 2.

The slide mechanism of the present embodiment may be provided at the box door 2. One of the first slider 714 and the second slider 713 is in transmission connection with the box door 2 or the box body 1, while the other of the first slider 714 and the second slider 713 is slidably connected to the door panel 21 located outside the box door 2. When the box door 2 rotates, the first slider 714 and the second slider 713 slide relative to each other to drive the door panel 21 to slide relative to the box door 2, allowing the door panel 21 to avoid obstacles on either side during opening and closing process of the box door 2.

Specifically, a first slider 714 being connected to the box body 1 through the traction mechanism and a second slider 713 being connected to the door panel 21 are taken as an example and the first pedestal 717 of the present embodiment may be provided at the box door 2. Two ends of the flexible cable 706 are connected to the first slider 714 and the second slider 713, respectively. This allows the first slider 714 to pull the second slider 713 through the flexible cable 706 for synchronously moving to drive the door panel 21 to slide relative to the box door 2.

By properly configuring an extension direction of the flexible cable 706, the first slider 714 and the second slider 713 move in opposite directions to drive the door panel 21 to avoid obstacles.

For example, when the box door 2 is rotated toward the outside of the box body 1 and is opened, the box door 2 drives the first slider 714 through the traction mechanism to slide in a direction close to the first hinge 4. Simultaneously, the first slider 714 drives the second slider 713 through the flexible cable 706 in the opposite direction (i.e., away from the first hinge 4), preventing the door panel 21 from interfering with external obstacles. During a process that the box door 2 is rotated toward a side of the box body 1 and is closed, the box body 1 drives the first slider 714 to slide in a direction away from the first hinge 4. Simultaneously, the first slider 714 drives the second slider 713 through the flexible cable 706 in the opposite direction (i.e., close to the first hinge 4), preventing the door panel 21 from interfering with external obstacles after the box door 2 is closed.

The first slider 714 may also be connected to the door panel 21. Correspondingly, the second slider 713 is connected to the box door 2 or box body 1 through a traction mechanism. The process is identical to that of the previous embodiment and is not further described here.

In the slide mechanism of the present embodiment, by providing the first guide rail and the second guide rail at either side of a first pedestal 717, the first slider 714 and the second slider 713 are slidably provided at the first guide rail and the second guide rail, respectively. Driven by a flexible cable 706, the first slider 714 and the second slider 713 may slide synchronously along their respective guide rails in opposite directions. One of the first slider 714 and the second slider 713 is in transmission connection with the box door 2 or the box body 1 through a traction mechanism, while the other is connected to the door panel 21 provided outside the box door 2. As the box door 2 rotates, the two sliders slide relative to each other to drive the door panel 21 to slide relative to the box door 2 and allow the door panel 21 to avoid obstacles on either side during opening and closing of the box door 2.

It should be noted that in actual applications, the design of the first slider 714 and the second slider 713 may be flexible and adaptable to different operating scenarios and performance requirements. They are not limited to specific shapes, sizes, or materials and may be customized and optimized based on specific needs.

From a material perspective, the first slider 714 and the second slider 713 may be made of materials with high wear resistance, low friction coefficient, and good stability, such as metal alloys, engineering plastics, or special lubricants. These materials are selected to enhance the durability of the sliders, reduce wear and noise during sliding, and ensure smooth sliding.

In terms of structural design, the first slider 714 and the second slider 713 may utilize a variety of guide rail contact surfaces, such as flat contact, ball contact, or sliding bearing contact. Each of these contact methods has its advantages and disadvantages. For example, ball contact reduces friction and wear but is more expensive, while flat contact offers a simpler structure but may require more frequent lubrication and maintenance. Therefore, factors such as usage conditions, cost-effectiveness, and ease of maintenance should be comprehensively considered during the selection process.

In addition, to enhance the load-bearing capacity and stability of the sliders, reinforcement ribs, support plates, or other auxiliary structures may be added to the first slider 714 and the second slider 713. These structures increase the rigidity and deformation resistance of the sliders, ensures stable sliding performance when bearing the weight of the door panel 21 and external forces.

In the present embodiment, the first guide rail and the second guide rail are provided sequentially along a width direction of the first pedestal 717, and the first guide rail and the second guide rail are provided in parallel to each other along width direction of the first pedestal 717. This ensures that while the lengths of the first guide rail and second guide rail meet the sliding distances of the first slider 714 and the second slider 713, the height and thickness of the first pedestal 717 may be effectively reduced. This results in a more compact structure and smaller occupation space.

In actual applications, due to factors such as machine tool accuracy, tool wear, and material unevenness, machining errors in the first guide rail and the second guide rail and the base may occur. These errors may include dimensional errors (such as length, width, and height deviations), shape errors (such as straightness, flatness, and roundness), and positional errors (such as coaxiality, parallelism, and perpendicularity). The parallelism between the first guide rail and second guide rail is assessed by measuring their relative positional deviation. This deviation must be kept within a certain tolerance range to ensure smooth sliding of the sliders and stable operation of the system. This tolerance range is generally determined based on design requirements, operating environment, and accuracy of the system.

It should be noted that in the present embodiment, the terms “parallel” and “perpendicular” should not be strictly defined in a geometric sense. At least manufacturing and mounting tolerances should be considered, and a tolerance of plus or minus 10° should be considered within the scope of patent protection.

According to an embodiment of the present application, as shown in FIG. 5, the flexible cable 706 includes a first flexible cable and a second flexible cable. The first flexible cable bypasses a first end of the first pedestal 717 and is connected to the first slider 714 and the second slider 713, respectively. The second flexible cable bypasses a second end of the first pedestal 717 and is connected to the first slider 714 and the second slider 713, respectively.

In the present embodiment, the first flexible cable bypasses a first end of the first pedestal 717 and connected to the first slider 714 and the second slider 713 respectively. When the first slider 714 slides in a direction away from the end of the first pedestal 717 under the drive of the box door 2 or the box body 1 through the traction mechanism, the first slider 714 drives the second slider 713 to slide in a direction close to the end of the first pedestal 717 through the first flexible cable. At the same time, the second flexible cable bypasses a second end of the first pedestal 717 and connected to the first slider 714 and the second slider 713 respectively. When the first slider 714 slides in a direction away from the second end of the first pedestal 717 under the drive of the box door 2, the first slider 714 drives the second slider 713 to slide in a direction closer to of the other end the first pedestal 717 through the second flexible cable. This ensures that when the first slider 714 slides toward either end of the first pedestal 717, the second slider 713 and the first slider 714 are driven to slide in the opposite direction. This allows the door panel 21 to slide relative to the box door 2 as it rotates when the box door 2 is opened and closed, preventing interference with obstacles that could affect the opening and closing of the box door 2.

The flexible cable 706 is one of a steel wire rope, steel stranded wire, or hemp rope. The selection of the flexible cable 706 depends on the load it must withstand, the operating environment, and the intended use. Steel wire rope or steel stranded wire is recommended for applications requiring heavy loads and harsh environments; hemp rope may be considered for applications with lighter loads and milder environments. Under the premise of satisfying the intended use, the cost differences between different materials are considered and the most cost-effective material is selected. Furthermore, the steel wire ropes and steel stranded wire may require regular inspection and maintenance during use to ensure their performance and safety; hemp ropes, on the other hand, are relatively easy to replace and maintain.

Specifically, both the second slider 713 and the first slider 714 are provided with a connector 711 for fixing the flexible cable 706.

In an embodiment of the present application, as shown in FIG. 5, the slide mechanism further includes: a first fixation base 701 and a second fixation base 702. The first fixation base 701 is connected to a first end of the first pedestal 717 and is formed with a first limit slot. Two ends of the first limit slot abut against one end of the first guide rail and second guide rail, and a part of the first flexible cable is slidably provided at the first limit slot. The second fixation base 702 is connected to the second end of the first pedestal 717 and formed with a second limit slot. Two ends of the second limit slot abut against the other end of the first guide rail and second guide rail, and a part of the first flexible cable is slidably provided at the second limit slot.

In the present embodiment, the first fixation base 701 and the second fixation base 702 are respectively provided at two ends of the first pedestal 717, and the first fixation base 701 and the second fixation base 702 are respectively formed with the first limit slot and the second limit slot abutting against the first guide rail and the second guide rail for respectively limiting and guiding the positions of the first flexible rope and the second flexible rope, and thus the first flexible rope and the second flexible rope smoothly slide.

Specifically, the first fixation base 701 is provided with a first fixation hole, and the first pedestal 717 is provided with a first waist-type hole extending along a width direction of the first pedestal 717. The slide mechanism further includes a first adjustment member 704 and the first adjustment member 704 penetrates through the first fixation hole and is slidably provided at the first waist-type hole to adjust a degree of tension of the first flexible cable by adjusting a position of the first adjustment member 704 within the first waist-type hole.

In the present embodiment, by adjusting the position of the first adjustment member 704 within the first waist-type hole, the position of the first fixation base 701 may be adjusted along the width of the first pedestal 717, and the first fixation base 701 can tighten or loosen the first flexible cable, adjusting a degree of tension of the first flexible cable.

Since the first flexible cable and second flexible cable are located at the first fixation base 701 and the second fixation base 702 on either side of the first pedestal 717, respectively, and are connected to two ends of the first slider 714 and the second slider 713, when the movement of the first fixation base 701 relative to the first pedestal 717 is adjusted through the first waist-type hole, a degree of tension of the first flexible cable is adjusted accordingly, and a degree of tension of the second flexible cable is also adjusted accordingly as the first fixation base 701 pulls on the first flexible cable.

The second fixation base 702 may be also provided with a first fixation hole, and the first pedestal 717 is provided with a first waist-type hole extending along a width direction of the first pedestal 717. The slide mechanism further includes a first adjustment member 704 and the first adjustment member 704 penetrates through the first fixation hole and is slidably provided at the first waist-type hole to adjust a degree of tension of the second flexible cable by adjusting a position of the first adjustment member 704 within the first waist-type hole.

In the present embodiment, by adjusting the position of the first adjustment member 704 within the first waist-type hole, the position of the second fixation base 702 may be adjusted along the width of the first pedestal 717, and the second fixation base 702 can tighten or loosen the second flexible cable, adjusting a degree of tension of the second flexible cable.

Since the first flexible cable and second flexible cable are located at the first fixation base 701 and the second fixation base 702 on either side of the first pedestal 717, respectively, and are connected to two ends of the first slider 714 and the second slider 713, when the movement of the second fixation base 702 relative to the first pedestal 717 is adjusted through the first waist-type hole, a degree of tension of the second flexible cable is adjusted accordingly, and a degree of tension of the first flexible cable is also adjusted accordingly as the second fixation base 702 pulls on the second flexible cable.

Furthermore, in some embodiments, the first fixation base 701 is provided with a second waist-type hole extending along a width direction of the first pedestal 717. The first pedestal 717 is provided with a second fixation hole. The slide mechanism further includes a second adjustment member 703, and the second adjustment member 703 sequentially penetrates through the second waist-type hole and the second fixation hole to be fixed to an external structure to adjust a position of the first fixation base 701 relative to the external structure by adjusting a position of the second adjustment member 703 in the second waist-type hole.

In the present embodiment, by providing a second waist-type hole in the first fixation base 701 and sequentially penetrating the second adjustment member 703 through the second waist-type hole and the second fixation hole to fix it in the external structure, the first fixation base 701 is fixed in the external structure to fix the slide mechanism to the external structure (such as the box door 2). Furthermore, the second adjustment member 703 may be fine-tuned along the second waist-type hole to adjust the position of the first fixation base 701, adjusting the position of the first fixation base 701 relative to the external structure.

The second fixation base 702 may further be provided with a second waist-type hole extending along the width directionof the first pedestal 717. The second adjustment member 703 sequentially penetrates through the second waist-type hole and the second fixation hole to be fixed to the external structure to adjust a position of the second fixation base 702 relative to the external structure by adjusting a position of the second adjustment member 703 in the second waist-type hole. The functions of the second adjustment member 703, the second waist-type hole, and the second fixation hole are similar to those in the above-described embodiment and are not further described here.

Furthermore, in some embodiments, a rotatable support bearing is provided in the first limit slot; and a part of the first flexible cable abuts against the support bearing in the first limit slot. In the present embodiment, by abutting a part of the first flexible cable against the support bearing, the movement and extension direction of the first flexible cable is adjusted to facilitate the first flexible cable to pass around an end of the first pedestal 717 to be connected to the first slider 714 and the second slider 713.

The second limit slot may be also provided with a rotatable support bearing. A part of the second flexible cable abuts against the support bearing in the second limit slot to adjust an extension direction of the second flexible cable and to facilitate the second flexible cable to pass around the end of the first pedestal 717 to be connected to the first slider 714 and the second slider 713.

Specifically, in some embodiments, the support bearing includes a first bearing 705 and a second bearing 716. The first bearing 705 and the second bearing 716 are respectively located at one end of the first guide rail and the second guide rail on the same side and at two sides of the first pedestal 717.

In an embodiment of the present application, as shown in FIG. 5, the traction mechanism includes a traction rod 709, a first rotary shaft fixation base 707, and a second rotary shaft fixation base 710. The first rotary shaft fixation base 707 is connected to the first slider 714, and the second rotary shaft fixation base 710 is connected to the box body 1. One end of the traction rod 709 is rotatably connected to the first rotary shaft fixation base 707, and the other end of the traction rod 709 is rotatably connected to the second rotary shaft fixation base 710.

In the present embodiment, by fixing the first rotary shaft fixation base 707 and second rotary shaft fixation base 710 to the first slider 714 and the box body 1, respectively, and connecting the first rotary shaft fixation base 707 to second rotary shaft fixation base 710 through the traction rod 709, a distance between the first slider 714 and the second rotary shaft fixation base 710 remains constant. When the box door 2 rotates relative to the box body 1, the angle between the box body 1 and the box door 2 changes. The first slider 714 is pulled by the transmission connection between the traction rod 709, the first rotary shaft fixation base 707 and second rotary shaft fixation base 710, the first slider 714 slides on the first pedestal 717 to drive the second slider 713 to slide in turn and move the door panel 21 relative to the box door 2.

Specifically, one end of the traction rod 709 is rotatably connected to the first rotary shaft fixation base 707 through a pin 708 and a third bearing 715, while the other end of the traction rod 709 is rotatably connected to the second rotary shaft fixation base 710 through another pin 708 and another third bearing 715.

In another embodiment of the present application, as shown in FIG. 1 and FIG. 4, a door body assembly is provided, including: a box door 2, a door panel 21, and the slide mechanism as provided in any of the aforementioned embodiments. The box door 2 is rotatably connected to the box body 1, configured for opening or closing a storage space of the box body 1. The door panel 21 is slidably provided at the outside of the box door 2. The slide mechanism is provided at the box door 2, a first slider 714 is in transmission connection with the box body 1, and a second slider 713 is connected to the door panel 21. During the opening or closing process of the box door 2, the first slider 714 and the second slider 713 move in opposite directions to drive the door panel 21 to move relative to the box door 2.

Specifically, during a process that the box door 2 is rotated toward the outside of the box body 1 and is opened, the first slider 714 slides in a direction close to the first hinge 4 driven by the box door 2 through the traction mechanism to drive the door panel 21 to slide in a direction away from the first hinge 4, preventing the door panel 21 from interfering with external obstacles. Similarly, during a process that the box door 2 is rotated toward a side of the box body 1 and is closed, the slide mechanism drives the door panel 21 to slide toward the first hinge 4, preventing the door panel 21 from interfering with obstacles after the box door 2 is closed.

According to the door body assembly of the present embodiment of the present application, a slide mechanism is provided at the box door 2. The slide mechanism is connected to the box door 2 and the door panel 21, respectively to drive the door panel 21 to slide in the width direction of the box door 2 during a process that the box door 2 is rotated relative to the box body 1 and is opened and closed, and the door panel 21 may avoid obstacles such as walls and objects when the box door 2 is closed or opened.

Since the slide mechanism exhibits the beneficial effects of the above-described embodiment, the door body assembly also exhibits the beneficial effects of the above-described embodiment. The specific implementation thereof will be referred to the above-described embodiment and is not further described herein.

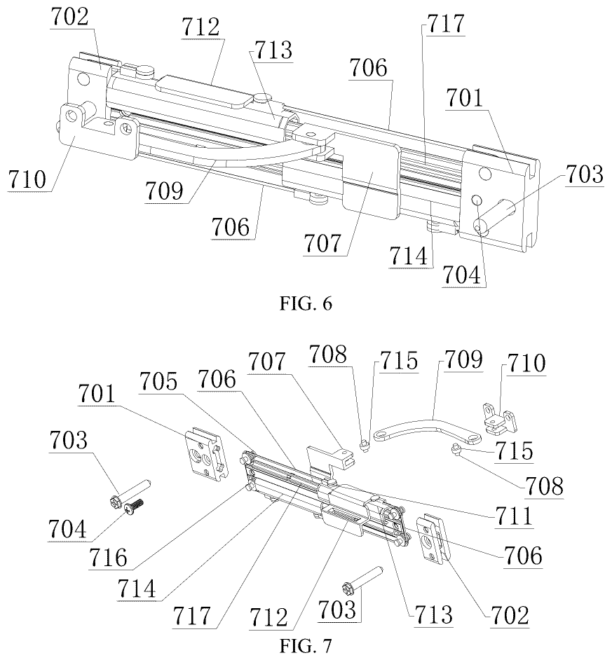

In an embodiment of the present application, as shown in FIG. 5 and FIG. 6, the second slider 713 is provided with a first connection block 712. The first connection block 712 is formed with a slot to which the door panel 21 is hanged.

In the present embodiment, by providing the first connection block 712 at the second slider 713 and providing the slot at the first connection block 712, the door panel 21 is also provided with a corresponding connection component (such as a hook or insert) matched with the slot to mount the door panel 21 at the first connection block 712 and the door panel 21 may slide along the second slider 713. This also facilitates the user to remove the door panel 21 from the second slider 713 when needed, meeting the user's needs in various scenarios.

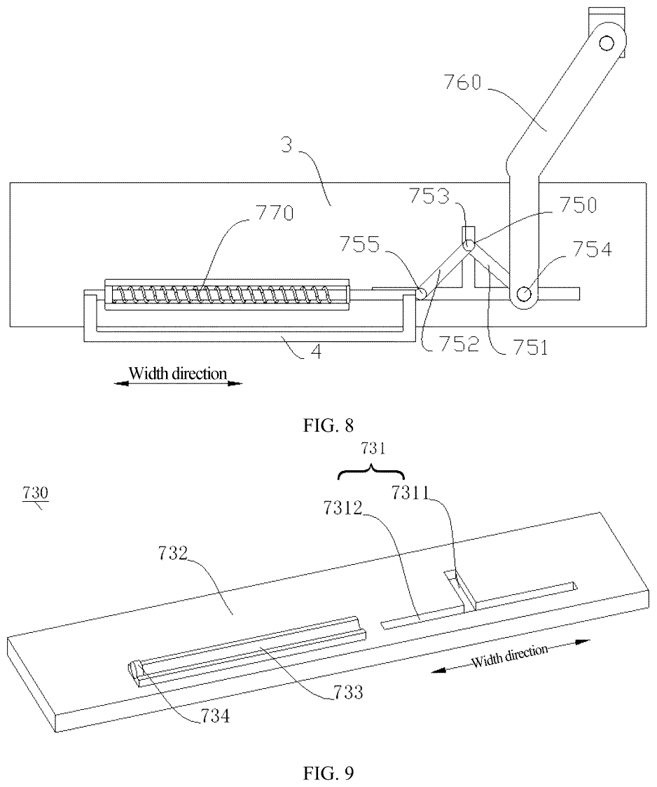

According to another embodiment of the present application, in addition to the above-described dual-guide rail and dual-slider structure, the slide mechanism of the present application may further adopt the structures shown in FIG. 8 to FIG. 10. The slide mechanism includes a guide 730, a slide member 740, a link assembly 750, and a drive rod 760.

The guide 730 is provided at the box door and is provided with a guide structure 731. The slide member 740 is provided at the door panel and is movably provided at the guide 730 along the width direction of the box door.

The link assembly 750 is movably provided at the guide structure 731 and may be deformed under the guidance of the guide structure 731. A second end of the link assembly 750 is movably connected to the slide member 740.

The drive rod 760 is provided at the box body and movably connected to a first end of the link assembly 750. This drives the link assembly 750 to be deformed during the door opening and closing process to drive the slide member 740 to move the door panel along the width direction through the link assembly 750.

As shown in the drawing, the box body is provided at a hinge with a hinge shaft. The box door is rotatably provided at the hinge shaft to open or close the box door relative to the box body.

The guide structure 731 ensures that the link assembly 750 moves along a predetermined path or direction, preventing it from deviating from a predetermined trajectory. It also guides the structural deformation of the link assembly 750 to drive the slide member 740 to move along the width direction of the box door.

Alternatively, the guide structure 731 may guide the link assembly 750 along the teeth of a sprocket by matching the sprocket with a chain. Alternatively, the guide structure 731 may guide the link assembly 750 along the cross-section of the guide rail by matching the slide block 742 with a guide rail.

Through the structural deformation of the link assembly 750, a gap between the second end the link assembly 750 and the hinge changes to change a gap between the slide member 740 and the hinge in turn, further changing a distance between the door panel connected to the slide member 740 and the hinge.

Alternatively, the link assembly 750 may be a parallelogram linkage or a crank-rocker mechanism.

In the slide mechanism shown in the present embodiment, by providing the guide 730 at the box door, and a slide member 740 at the door panel, the slide member 740 is movably provided at the guide 730 along the width direction of the box door. By providing the guide structure 731 at the guide 730, the guide structure 731 guides the structural deformation of the link assembly 750 and movably connects the second end of the link assembly 750 to the slide member 740. When the box door is opened, the drive rod 760 drives the first end of the link assembly 750, and the link assembly 750 is deformed structurally. The second end of the link assembly 750 pulls the slide member 740 to move away from the hinge to further drive the door panel to move in a direction away from the hinge along the width of the box door, preventing interference between the door panel and a cupboard at a side. When the box door is closed, the drive rod 760 drives the first end of the link assembly 750, and the link assembly 750 is deformed structurally. The second end of the link assembly 750 pulls the slide member 740 to move in a direction close to the hinge to further drive the door panel to move in a direction close to the hinge along the width of the box door and to restore the door panel to its original position, ensuring that the door panel does not interfere with the cupboards surrounding the refrigeration apparatus.

In some embodiments, as shown in FIG. 8, the link assembly 750 includes a first link 751 and a second link 752.

The drive rod 760 is rotatably connected to a first end of the first link 751. A second end of the first link 751 is rotatably connected to a first end of the second link 752 through a first hinge shaft 753. The first hinge shaft 753 is provided at the guide structure 731 and moves along a thickness direction of the door panel under the guidance of the guide structure 731, and a second end of the second link 752 is rotatably connected to the slide member 740.

The drive rod 760 is configured to drive the first end of the first link 751 to move along the width direction. The first link 751 is configured to drive the first hinge shaft 753 to move along the thickness direction to change an angle between the first link 751 and the second link 752. Consequently, the second link 752 drives the slide member 740 to move in a direction opposite to the driving direction of the drive rod 760.

The drive rod 760 provides a driving force to the first end of the first link 751 and the guide structure 731 may limit a movement path of the first hinge shaft 753 to allow the first hinge shaft 753 to move only along the thickness direction of the box door. This in turn changes the angle between the first link 751 and the second link 752 to allow the second link 752 to move along the width direction.

During the box door opening, the drive rod 760 drives the first end of the first link 751 to move along the width direction in a direction close to the hinge. The first link 751 drives the first hinge shaft 753 to move along the thickness direction in a direction close to the slide member 740 to increase the angle between the first link 751 and the second link 752. The second link 752 is pushed to move in a direction away from the hinge to in turn drive the slide member 740 along the width direction in a direction away from the hinge, preventing interference between the door panel and the cupboard.

During the box door closing process, the drive rod 760 drives the first end of the first link 751 to move along the width direction in a direction away from the hinge. The first link 751 drives the first hinge shaft 753 to move along the thickness direction in a direction away from the slide member 740 to decrease the angle between the first link 751 and the second link 752. The second link 752 is pushed to move in a direction close to the hinge to in turn drive the slide member 740 along the width direction in a direction close to the hinge to restore the door panel to its original position, ensuring that the door panel does not interfere with the cupboards surrounding the refrigeration apparatus.

In the present embodiment, by providing the first link 751, the second link 752, and the first hinge shaft center 753 in the link assembly 750 and by limiting the movement of the first hinge shaft center 753 in the thickness direction, the angle between the first link 751 and the second link 752 is changed to allow the second link 752 to drive the slide member 740 in the width direction, thereby achieving movement of the door panel relative to the box door. This results in a simple structure and a compact size.

In some embodiments, as shown in FIG. 8, the drive rod 760 includes a linkage member.

A first end of the linkage member is rotatably provided at a fixed position on the box body of the refrigeration apparatus, and a second end of the linkage member is rotatably connected to the first end of the first link 751. The fixed position is provided offset from a hinge position between the box door and the box body.

During the box door opening, the linkage member drives the first end of the first link 751 to move toward a side close to the hinge position, and the second link 752 drives the slide member 740 to move the door panel toward a side away from the hinge position.

During the box door closing process, the linkage member drives the first end of the first link 751 to move toward a side away from the hinge position, and the second link 752 drives the slide member 740 to move the door panel toward a side close to the hinge position.

In the present embodiment, the first end of the linkage member is rotatably provided at the hinge. When the box door rotates relative to the box body about the hinge shaft, the second end of the linkage member rotates in a circular motion centered at the hinge shaft. Since the first end of the linkage member is provided offset from the hinge shaft, a distance between the second end of the linkage member and the hinge changes as the linkage member rotates to drive the link assembly 750 close to or away from the hinge along the width of the box door.

During the box door opening, the box door rotates to drive the linkage member to rotate. The second end of the linkage member drives the first end of the first link 751 to move toward a side close to the hinge position. The second end of the second link 752 drives the slide member 740 to move toward a side away from the hinge position, causing the door panel to move toward a side away from the hinge position.

During the box door closing process, the box door rotates to drive the linkage member to rotate. The second end of the linkage member drives the first end of the first link 751 to move toward a side away from the hinge position. The second end of the second link 752 drives the slide member 740 to move toward a side away from the hinge position, causing the door panel to move toward a side close to the hinge position.

In the present embodiment, by providing the first end of the linkage member offset from the hinge position between the box door and the box body, the second end of the linkage member may drive the first end of the first link 751 to in turn drives the second link 752 to move the slide member 740 in the width direction. The opening and closing of the box door controls the linkage member to drive the transmission of link assembly 750, and the slide member 740 may drive the door panel to move in the width direction without an additional drive device to allow the movement of the door panel relative to the box door to be synchronized with the opening and closing of the box door.

In some embodiments, as shown in FIG. 9, the guide structure 731 includes a first limit slot 7311.

The first limit slot 7311 extends in the thickness direction.

The first hinge shaft 753 is inserted into the first limit slot 7311 and is movable along the extension direction of the first limit slot 7311.

The first limit slot 7311 is configured to limit the first hinge shaft 753 to allow the first hinge shaft 753 to move only in the thickness direction. This allows the angle between the first link 751 and the second link 752, respectively connected to the first hinge shaft 753 to change and the second end of the first link 751 and the second end of the second link 752 move in opposite directions.

In the present embodiment, the first limit slot 7311 guides the movement of the first hinge shaft 753. Furthermore, the first limit slot 7311 may be directly formed at the upper surface of the guide 730, without occupying additional space and ensuring a compact structure for the slide mechanism.

In some embodiments, as shown in FIG. 9, the guide structure 731 further includes a second limit slot 7312.

The second limit slot 7312 extends in the thickness direction and communicates with the first limit slot 7311.

The drive rod 760 is rotatably connected to the first end of the first link 751 through a second hinge shaft 754 and the second end of the second link 752 is rotatably connected to the slide member 740 through a third hinge shaft 755. The second hinge shaft 754 and the third hinge shaft 755 are respectively inserted into the second limit slot 7312 and are movable along the extension direction of the second limit slot 7312;

where the second hinge shaft 754 and the third hinge shaft 755 are respectively located at either side of the first limit slot 7311.

The second limit slot 7312 is configured to limit the second hinge shaft 754 and the third hinge shaft 755 to allowing them to move only in the width direction. This allows the second link 752 to drive the slide member 740 in this direction. In the present embodiment, the second limit slot 7312 prevents deviation in the direction of movement of the slide member 740, ensuring the reliable and stable movement of the slide member 740 and, consequently, the reliable movement of the door panel along the width direction of the box door.

In some embodiments, as shown in FIG. 8, the slide mechanism further includes an elastic member 770.

The elastic member 770 is provided between the guide 730 and the slide member 740.

When the link assembly 750 drives the slide member 740 to move toward the side away from the hinge position, the slide member 740 compresses the elastic member 770 while moving the door panel.

When the link assembly 750 drives the slide member 740 to move toward the side close to the hinge position, the elastic member 770 drives the slide member 740 to move the door panel toward the hinge position.

The hinge position is located between the box door and the box body, and the box door is rotatably provided at the box body about the hinge position.

When the link assembly 750 drives the slide member 740 to move toward the side away from the hinge position, the elastic member 770 is compressed in a direction away from the hinge and accumulates elastic potential energy.

When the link assembly 750 drives the slide member 740 to move toward the side close to the hinge position, the elastic potential energy of the elastic member 770 is released, and the elastic force of the elastic member 770 acts at the slide member 740 to drive the slide member 740 toward the hinge position.

Specifically, the elastic member 770 may be an elastic sheet, an elastic block, or a spring.

In the present embodiment, by providing the elastic member 770 at the slide mechanism, more stable and reliable movement of the slide member 740 relative to the guide 730 can be ensured based on the elastic deformation of the elastic member 770.

In some embodiments, as shown in FIG. 8 to FIG. 10, the guide 730 includes a fixation panel 732 and a slide recess 733.

The fixation panel 732 is provided at the box door.

The slide recess 733 is provided at the fixation panel 732 and extends along the width direction. At least a part of the slide member 740 is movably provided within the slide recess 733 along the width direction.

In the present embodiment, the fixation panel 732 is fixedly connected to the box door, and the slide recess 733 guides the movement of the slide member 740 along the width direction of the box door. Stable and reliable movement of the slide member 740 along the width of the box door may be ensured based on sliding engagement between the slide member 740 and the slide recess 733.

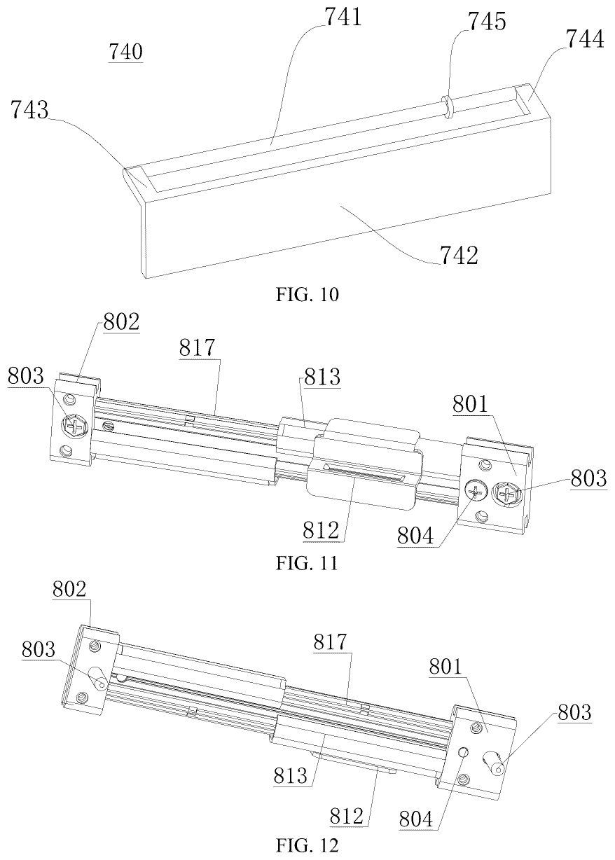

In some embodiments, as shown in FIG. 9 and FIG. 10, the guide 730 further includes a slide bushing 734 provided at the end of the slide slot 733 away from the hinge.

The slide member 740 includes a guide rod 741 and a slide block 742. The guide rod 741 penetrates through the slide bushing 734 and is provided with a slide contact 745 movably provided in the slide recess 733 along the width direction. The slide block 742 is connected to the guide rod 741 and is connect to the door panel.

The elastic member 770 is provided between the slide bushing 734 and the slide contact 745.

The slide recess 733 of the present embodiment is provided in an arc shape to adapt to the outer wall of the guide rod 741. The slide bushing 734 is configured to guide the movement of the guide rod 741 relative to the slide recess 733. As the slide member 740 moves at the slide recess 733, the slide contact 745 also moves accordingly. The slide bushing 734 is fixed relative to the fixation panel 732 and the elastic member 770 is limited between the slide bushing 734 and the slide contact 745. When the guide rod 741 moves toward the side away from the hinge, the slide member 740 moves, the slide contact 745 moves toward the slide bushing 734 to compress the elastic member 770 between the slide bushing 734 and the slide contact 745. When the guide rod 741 moves toward a side close to the hinge, the elastic member 770 releases its elastic potential energy and extends, causing the slide contact 745 to move away from the slide bushing 734. The slide bushing 734 and the slide contact 745 limit the elastic member 770 from both sides to ensure reliable compression and extension of the elastic member 770.

Furthermore, one end of the slide block 742 is connected to the guide rod 741 and the other end to the door panel. Sliding may drive the door panel to move along the width direction of the box door as the guide rod 741 moves along the width direction of the box door.

In some embodiments, as shown in FIG. 8, the elastic member 770 includes a spring sleeved outside the guide rod 741 and limited between the slide bushing 734 and the slide contact 745.

When the elastic member 770 is provided as a spring, its hollow structure allows the spring to sleeve the outer wall of the guide rod 741. The spring undergoes compression and extension along a length direction of the guide rod 741. Furthermore, the slide bushing 734 and slide contact 745 limit the spring from two ends of the guide rod 741 to stop two ends of the spring when the spring is compressed and extended. The spring in the present embodiment allows a simple and compact structure when the door panel is restored relative to the box door, and the mounting space of the box door is saved.

In some embodiments, as shown in FIG. 8 and FIG. 9, the slide member 740 further includes a first connection arm 743 and a second connection arm 744.

The first connection arm 743 and the second connection arm 744 are spaced apart along the width direction. A first end of the guide rod 741 is connected to a first end of the slide block 742 through the first connection arm 743, and a second end of the guide rod 741 is connected to a second end of the slide block 742 through the second connection arm 744.

The slide bushing 734 and slide contact 745 are located between the first connection arm 743 and the second connection arm 744.

The first connection arm 743 and the second connection arm 744 connect the guide rod 741 and the slide block 742 at their respective ends. This ensures a secure connection between the guide rod 741 and the slide block 742, and facilitates the slide block 742 to be aligned with the width direction of the box door as it moves along the width direction.

Furthermore, in the present embodiment, the slide block 742 is provided perpendicular to the first connection arm 743 and the second connection arm 744. When the door panel is mounted at the slide block 742, the fixation panel 732 is mounted at the top of the box door, the door panel is aligned in parallel with the box door to ensure flatness of mounting the door panel on the box door and facilitates its movement of the door panel along the box door.

In an embodiment, the slide mechanism, in addition to the aforementioned rail-slider or link forms, may also adopt a gear-rack form, a cable structure, or other similar forms. The specific structure is not limited, as long as the slide mechanism may drive the door panel to move relative to the box door. Correspondingly, the traction mechanism is also not limited to the above examples. For example, the traction mechanism may employ a cylinder, a cable, or other structures, which are not listed here. Furthermore, the traction mechanism may be either electric structure or a mechanical structure.

In an embodiment of the present application, as shown in FIG. 4, FIG. 11, and FIG. 12, the door body assembly further includes a first driven guide rail mechanism 8. The first driven guide rail mechanism 8 is provided in parallel to the slide mechanism at the box door 2 and includes a second pedestal 817 and a third slider 813. The second pedestal 817 is formed with a third guide rail, the third slider 813 is slidably provided at the third guide rail. The third slider 813 is provided with a second connection block 812 and the second connection block 812 is formed with a slot to which the door panel 21 is hanged.

In the present embodiment, the first driven guide rail mechanism 8 is provided in parallel to the slide mechanism at the box door 2. The first driven guide rail mechanism 8 includes a second pedestal 817, the second pedestal 817 is provided with the third guide rail and the third slider 813 that slides along the third guide rail. The third slider 813 is connected to the door panel 21 through a second connection block 812. The third slider 813 slides with the door panel 21 as it slides relative to the box door 2 for providing support and assisting in the sliding of the door panel 21, and ensuring smoother sliding relative to the box door 21. Furthermore, the first driven guide rail mechanism 8 matches with the slide mechanism to limit the direction of movement of the door panel 21, reducing any shaking of the door panel 21 during sliding and ensuring more stable sliding. Moreover, the slots in the second connection block 812 facilitate the user to mount the door panel 21 at the driven guide rail mechanism.

Furthermore, the first driven guide rail mechanism 8 further includes a third fixation base 801 and a fourth fixation base 802. Both the third fixation base 801 and the fourth fixation base 802 are provided with limit slots similar to those for the first second fixation base 701 and the second fixation base 702.

Specifically, the third fixation base 801 is provided with a third fixation hole, and the second pedestal 817 is provided with a third waist-type hole extending along a width direction of the second pedestal 817. A third adjustment member 804 penetrates through the third fixation hole and is slidably provided at the third waist-type hole to adjust a position of the third adjustment member 804 within the third waist-type hole.

The fourth fixation base 802 may be also provided with the third fixation hole, and the second pedestal 817 is provided with the third waist-type hole extending along a width direction of the second pedestal 817. The third adjustment member 804 penetrates through the third fixation hole and is slidably provided at the third waist-type hole to adjust a position of the third adjustment member 804 within the third waist-type hole.

Furthermore, the third fixation base 801 is provided with a fourth waist-type hole extending along the direction the width of the second pedestal 817. The first pedestal 817 is provided with a fourth fixation hole. A second adjustment member 803 sequentially penetrates through the fourth waist-type hole and a second fixation hole to be fixed to an external structure to adjust a position of the third fixation base 801 relative to the external structure by adjusting a position of the fourth adjustment member 803 in the fourth waist-type hole.

The fourth fixation base 802 may further be provided with the fourth waist-type hole extending along the width direction of the third pedestal 902. The fourth adjustment member 803 sequentially penetrates through the fourth waist-type hole and the fourth fixation hole to be fixed to the external structure to adjust a position of the fourth fixation base 802 relative to the external structure by adjusting a position of the fourth adjustment member 803 in the fourth waist-type hole.

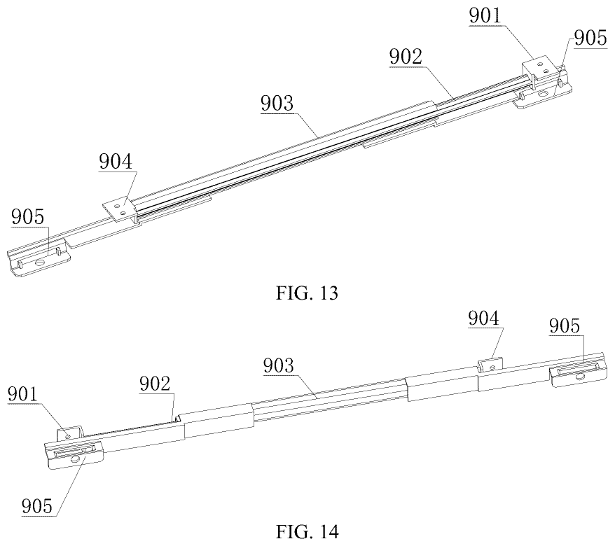

In an embodiment of the present application, as shown in FIG. 4, FIG. 13, and FIG. 14, the door body assembly further includes a second driven guide rail mechanism 9 provided at a different shaft of the slide mechanism. The second driven guide rail mechanism 9 includes the third pedestal 902 and a fourth slider 903. The third pedestal 902 is formed with a fourth guide rail and the fourth slider 903 is slidably provided at the fourth guide rail. The fourth slider 903 is provided with a plurality of third connection blocks 905, each of which has a slot to which the door panel 21 is hanged.

In the present embodiment, by providing the second driven guide rail mechanism 9, the fourth slider 903 of the second driven guide rail mechanism 9 may slide with the door panel 21 as it slides relative to the box door 2 for providing support and assisting in the sliding of the door panel 21, and ensuring more stable and smoother sliding relative to the box door 21.

At the same time, since the second driven guide rail mechanism 9 is provided at a different shaft of the slide mechanism, the third connection blocks 905 may match with the slide mechanism to limit the direction of movement of the door panel 21, preventing the door panel 21 from deflecting around the sliding direction during sliding, making the sliding process more stable and reliable.

In an embodiment of the present application, as shown in FIG. 13 and FIG. 14, two end of the third pedestal 902 of the second driven guide rail mechanism 9 are provided with a fifth fixation base 901 and a sixth fixation base 904 for being fixedly connected to the box door 2.

Furthermore, in an embodiment of the present application, as shown in FIG. 4 and FIG. 11 to FIG. 14, the slide mechanism, the first driven guide rail mechanism 8, and the second driven guide rail mechanism 9 are provided along the width direction of the box door 2. The first driven guide rail mechanism 8 is provided in parallel to the slide mechanism, while the second driven guide rail mechanism 9 is provided at a different shaft of the slide mechanism.

The width direction of the box door 2 is parallel to a plane on which the box door 2 rests and perpendicular to its axis of rotation, allowing the door panel 21 to move away from or toward the hinge shaft of the box door 2.

In the present embodiment, by providing the first driven guide rail mechanism 8 parallel to the slide mechanism, the third slider 813 may slide parallel to the slide mechanism, effectively assisting the door panel 21 in sliding relative to the box door 2 under the drive of the slide mechanism. Simultaneously, the second connection block 812 may match with the slide mechanism to limit the movement direction of the door panel 21, preventing it from swinging during movement. At the same time, since the second driven guide rail mechanism 9 is provided at a different shaft of the slide mechanism, the third connection blocks 905 may match with the slide mechanism to limit the direction of movement of the door panel 21, preventing the door panel 21 from deflecting around the sliding direction during sliding, making the sliding process more stable and reliable.

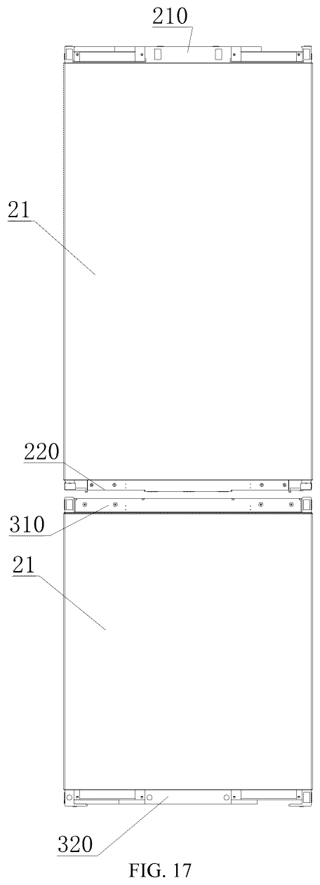

In an embodiment of the present application, as shown in FIG. 17 to FIG. 20, the door body assembly further includes: a first end cover 210 and a second end cover 220. The first end cover 210 is provided at one end of the box door 2 and is provided with a first mount slot 213 in which the slide mechanism and the first driven guide rail mechanism 8 are provided. The second end cover 220 is provided at the other end of the box door 2 and is provided with a second mount slot in which the second driven guide rail mechanism 9 is provided.

In the present embodiment, by providing the first end cover 210 and second end cover 220, respectively at each end of the box door 2, and forming the first mount slot 213 in the first end cover 210 for mounting the slide mechanism and the first driven guide rail mechanism 8, and the second mount slot in the second end cover 220 for mounting the second driven guide rail mechanism 9, the structure of the slide mechanism, the first driven guide rail mechanism 8, the second driven guide rail mechanism 9, and the box door 2 is made more compact and aesthetically pleasing.

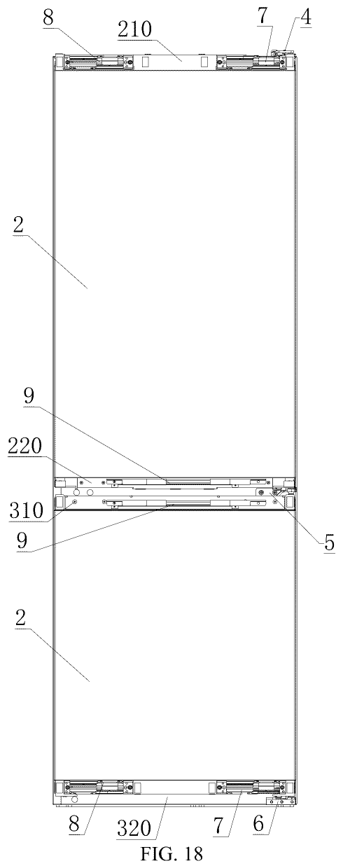

In an embodiment of the present application, as shown in FIG. 18, both the first driven guide rail mechanism 8 and the second driven guide rail mechanism 9 are provided along the width direction of the box door 2, the slide mechanism and the first driven guide rail mechanism 8 are provided at a top of the box door 2 and the second driven guide rail mechanism 9 is provided at a bottom of the box door 2.

In the present embodiment, by providing the slide mechanism and the first driven guide rail mechanism 8 at the top of the box door 2 and the second driven guide rail mechanism 9 at the bottom of the box door 2, the top of the box door 2 is connected to the door panel 21 through the slide mechanism and the first driven guide rail mechanism 8, while the bottom of the box door 2 is connected to the door panel 21 through the second driven guide rail mechanism 9. This provides a more stable and reliable connection between the door panel 21 and the box door 2.

In another embodiment of the present application, both the first driven guide rail mechanism 8 and the second driven guide rail mechanism 9 are provided along the width direction of the box door 2, the slide mechanism and the first driven guide rail mechanism 8 are provided at a bottom of the corresponding box door 2 and the second driven guide rail mechanism 9 of the door body assembly is provided at a top of the corresponding box door 2.

In the present embodiment, by providing the slide mechanism and the first driven guide rail mechanism 8 at the bottom of the box door 2 and the second driven guide rail mechanism 9 at the top of the box door 2, the top of the box door 2 is connected to the door panel 21 through the slide mechanism and the first driven guide rail mechanism 8, while the bottom of the box door 2 is connected to the door panel 21 through the second driven guide rail mechanism 9. This provides a more stable and reliable connection between the door panel 21 and the box door 2.

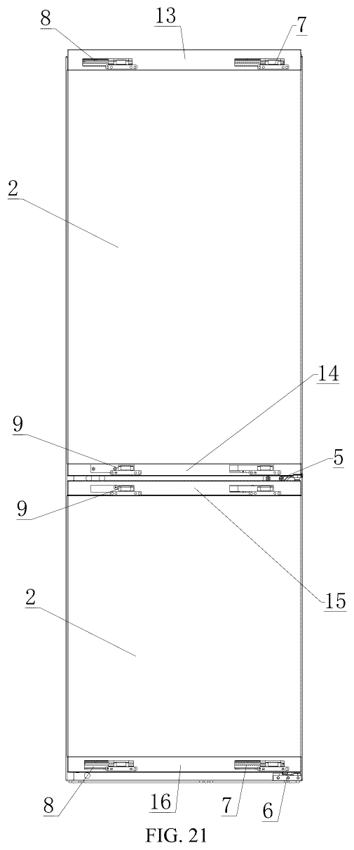

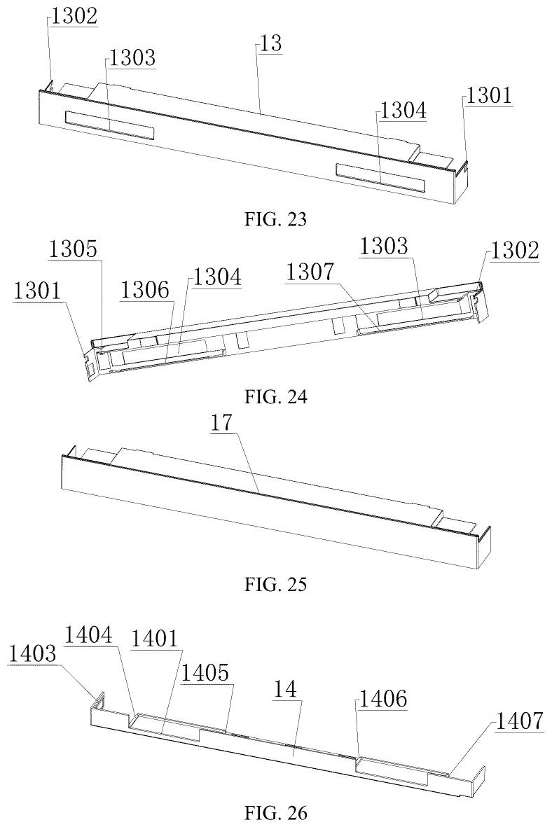

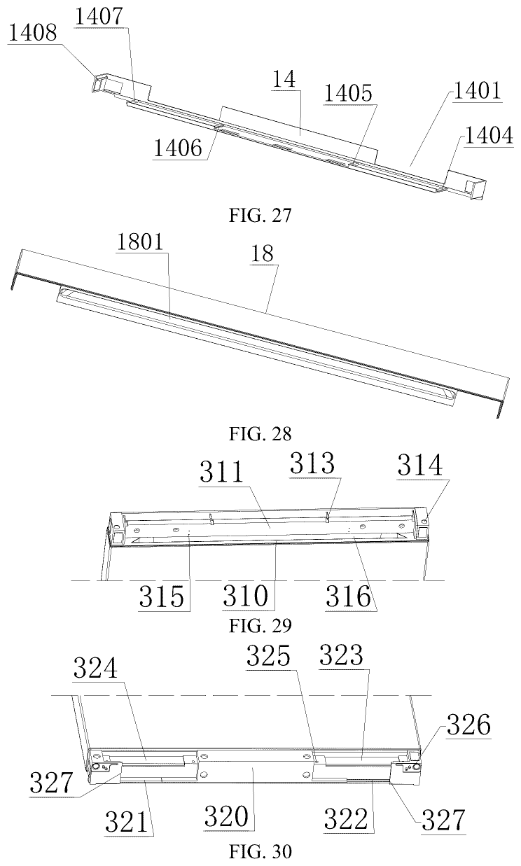

Furthermore, as shown in FIG. 21, FIG. 23, FIG. 24, FIG. 26, and FIG. 27, in an embodiment of the present application, the door body assembly further includes: a first primary decorative cover 13 and a second primary decorative cover 14. The first primary decorative cover 13 is detachably provided at the first end cover 210 and is formed with a first notch 1303 and a second notch 1304. An end of the first connection block 712 with a slot penetrates through the first notch 1303, and an end of the second connection block 812 with a slot penetrates through the second notch 1304. The second primary decorative cover 14 is detachably provided at the second end cover 220 and is formed with a third notch 1401 and an end of the first connection block 712 with a slot penetrates through the third notch 1401.

In the present embodiment, by providing the first primary decorative cover 13 at the box door 2, the first primary decorative cover 13 may cover the entire slide mechanism and the first driven guide rail mechanism 8, preventing them from being completely exposed and enhancing the appearance. Furthermore, the first primary decorative cover 13 is formed with a first notch 1303 and a second notch 1304 to allow the slide mechanism and the first driven guide rail mechanism 8 to extend through the first notch 1303 and the second notch 1304, respectively to the exterior of the first primary decorative cover 13 and connect to the door panel 21, thereby driving the door panel 21 to slide. By providing the second primary decorative cover 14 detachably at the box door 2 to cover the second driven guide rail mechanism 9, the second driven guide rail mechanism 9 is prevented from being exposed to enhance the overall aesthetics of the box door 2. The second driven guide rail mechanism 9 penetrates through the third notch 1401 and is connected to the door panel 21 for guiding the movement of the door panel 21 relative to the box door 2 during opening and closing of the box door 2.

The colors and materials of the first primary decorative cover 13 and the second primary decorative cover 14 of the present embodiment may be designed to match the material and color of the exterior surface of the box door 2 (for example, maintaining consistency or forming a decorative pattern with the exterior surface of the box door 2) to enhance the overall aesthetics of the cupboard.

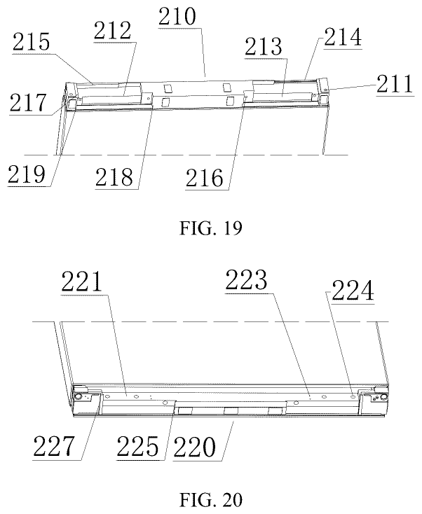

In an embodiment of the present application, as shown in FIG. 19, FIG. 23, and FIG. 24, one of the first primary decorative cover 13 and the first end cover 210 is provided with a first protrusion, and the other thereof is provided with a first recess corresponding to the first protrusion. The first primary decorative cover 13 is detachably connected to the first end cover 210 through the first protrusion and first recess.

As shown in FIG. 20, FIG. 26, and FIG. 27, one of the second primary decorative cover 14 and the second end cover 220 is provided with a second protrusion, and the other thereof is provided with a second recess corresponding to the second protrusion. The second primary decorative cover 14 is detachably connected to the second end cover 220 through the second protrusion and the second recess.

In the present embodiment, the first end cover 210 is provided with a first protrusion, and the first primary decorative cover 13 is provided with a first recess. The first protrusion and the first recess may be snapped each other to fix the first primary decorative cover 13 and the first end cover 210.

The positions of the first protrusion and the first recess are interchangeable, that is, the first end cover 210 is provided with the first recess, and the first primary decorative cover 13 is provided with the first protrusion.

Similarly, as shown in FIG. 20, FIG. 26, and FIG. 27, the second end cover 220 is provided with a second protrusion, and the second primary decorative cover 14 is provided with a second recess. The second protrusion and the second recess may be snapped each other to fix the second primary decorative cover 14 and the second end cover 220.

The positions of the second protrusion and the second recess are interchangeable, that is, the second end cover 220 is provided with the second recess, and the second primary decorative cover 14 is provided with the second protrusion.

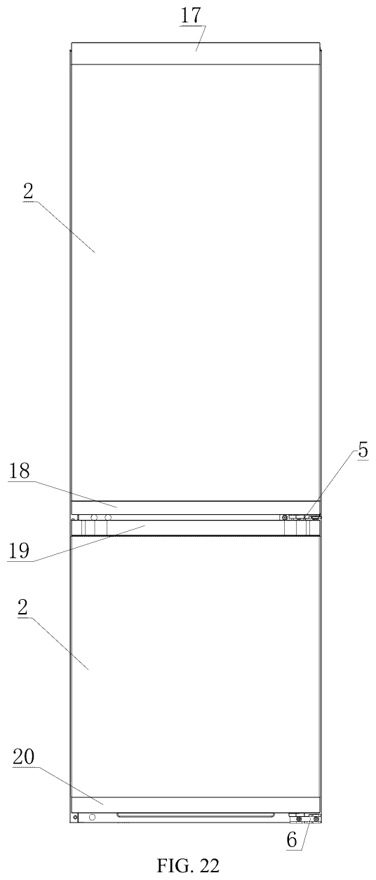

In an embodiment of the present application, as shown in FIG. 22, FIG. 25, and FIG. 28, the door body assembly further includes a first secondary decorative cover 17 and a second secondary decorative cover 18. The first secondary decorative cover 17 is detachably provided at the first end cover 210 to shield the slide mechanism and the first driven guide rail mechanism 8; the second secondary decorative cover 18 is detachably provided at the second end cover 220 to shield the second driven guide rail mechanism 9.

In the present embodiment, in some usage scenarios, no door panel 21 is required at the outside of the box door 2. Instead, the first secondary decorative cover 17 may replace the first primary decorative cover 13 on the first end cover 210, and the second secondary decorative cover 18 may replace the second primary decorative cover 14 on the second end cover 220 to shield the two driven guide rail mechanisms of the slide mechanism. This improves the visual consistency of the box door 2, enhances its aesthetics, and accommodates different user needs.

In some embodiments of the present application, one of the first secondary decorative cover 17 and the first end cover 210 is provided with a first protrusion, and the other thereof is provided with a first recess corresponding to the first protrusion. The first secondary decorative cover 17 is detachably connected to the first end cover 210 through the first protrusion and the first recess.

One of the second primary decorative cover 18 and the second end cover 220 is provided with a second protrusion, and the other thereof is provided with a second groove corresponding to the second protrusion. The second primary decorative cover 18 is detachably connected to the second end cover 220 through the second protrusion and the second recess.

In the present embodiment, the first end cover 210 is provided with a first protrusion, and the first secondary decorative cover 17 is provided with a first recess. The first protrusion and the first recess may be snapped each other to fix the first secondary decorative cover 17 and the first end cover 210.

The positions of the first protrusion and the first recess are interchangeable, that is, the first end cover 210 is provided with a first recess, and the first secondary decorative cover 17 is provided with a first protrusion.

Similarly, the second end cover 220 is provided with a second protrusion, and the second secondary decorative cover 18 is provided with a second recess. The second protrusion and the second recess may be snapped each other to fix the second secondary decorative cover 18 and the second end cover 220.

The positions of the second protrusion and the second recess are interchangeable, i.e., the second end cover 220 is provided with the first recess, and the second secondary decorative cover 18 is provided with the second protrusion.

In some embodiments, at least one of the first end cover 210, the second end cover 220, the first secondary decorative cover 17, and the second secondary decorative cover 18 is provided with a hand grip slot for the user to open or close the box door 2.

In some embodiments, by providing the hand grip slot at at least one of the first end cover 210, the second end cover 220, the first secondary decorative cover 17, and the second secondary decorative cover 18, it facilitates the user's hand access to manually open or close the box door 2, resulting in a simple structure and convenient operation.

As shown in FIG. 28, when there is no need to mount the door panel 21, the second driven guide rail mechanism 9 in the second mount slot may be removed. Accordingly, a position of the second auxiliary decorative cover 18 corresponding to the second mount slot is provided with a concave handle portion 1801, which is convenient for users to manually open and close the box door 2.

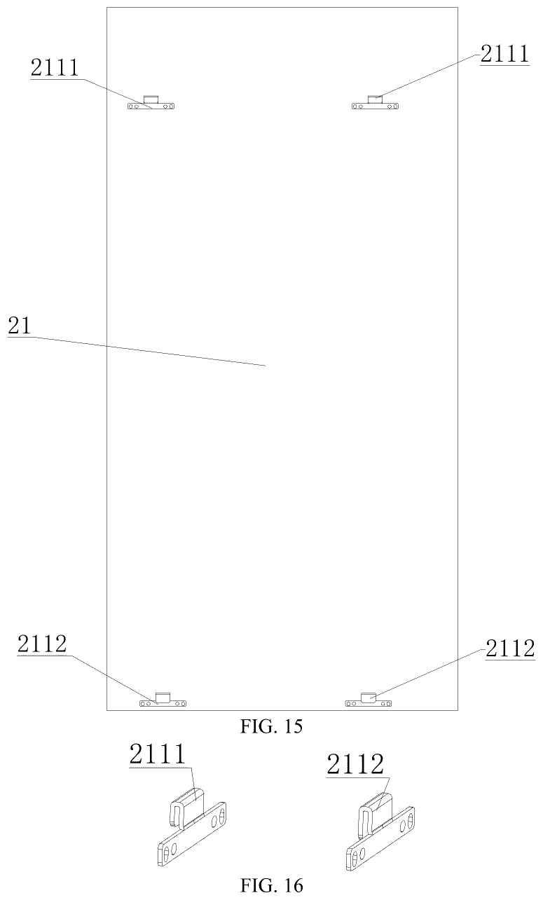

In an embodiment of the present application, as shown in FIG. 15 and FIG. 16, a top of the door panel 21 is provided with a first hook 2111, and a bottom of the door panel 21 is provided with a second hook 2112. The second hook 2112 has a length longer than that of the first hook 2111. The first hook 2111 and the second hook 2112 are inserted into corresponding slots.

In the present embodiment, by providing the first hook 2111 and the second hook 2112 at the top and bottom of the door panel 21, respectively, the door panel 21 may be connected to the slots of the slide mechanism and the two driven guide rail mechanisms through the first hook 2111 and the second hook 2112, thereby slidably connecting the door panel 21 to the box door 2. The first hook 2111 and the second hook 2112 are located at the top and bottom of the door panel 21, respectively, preventing the door panel 21 from shaking.

Furthermore, the second hook 2112 has a length longer than that of the first hook 2111. When the door panel 21 is mounted at the outside of the box door 2, the slot at the bottom of the door panel 21 is first hooked with the second hook 2112 to initially position the bottom of the door panel 21. The position and angle of the door panel 21 are then adjusted to insert the first hook 2111 at the top of the door panel 21 into the slot at the top of the box door 2. This makes it easier for the user to align the slot with the first hook 2111 and the second hook2112, and it facilitates installation.

Specifically, the first hook 2111 includes a connection portion and a hook portion provided at the connection portion. The hook portion is hook-shaped and is designed to be hanged into the slot. The connection portion is provided with at least one horizontally extending waist-type hole and at least one vertically extending waist-type hole. The door panel 21 is provided with a fastening hole corresponding to the first hook 2111. The door panel 21 is fixedly connected to the first hook 2111 through a fastener that penetrates through the waist-type hole and the fastening hole. By adjusting the position of the fastener within the waist-type hole, the position of the first hook 2111 may be fine-tuned, facilitating mounting of the door panel 21 and fine-tuning its position and angle.

The second hook 2112 has a similar structure to the first hook 2111 and is not further described here.

In an embodiment of the present application, the door body assembly and the box body 1 are provided within a mounting space formed between a first cupboard body and a second cupboard body. During the opening or closing of the box door 2, a slide mechanism is configured to drive the door panel 21 to move a predetermined distance on the box door 2, to avoid the box door 2 from the sidewalls of the first cupboard body and second cupboard body.

In the present embodiment, the box body 1 is provided between the first cupboard body and second cupboard body. The material and color of the door panel 21 may be designed to be similar or identical to the outer walls of the cupboard. When the box door 2 is closed, the door panel 21 is flush with the outer walls of the first cupboard body and second cupboard body on either side, maintaining visual consistency and minimizing the gap between them, enhancing the appearance.

When the box door 2 rotates outward to be opened, the slide mechanism drives the door panel 21 to slide a predetermined distance away from the first hinge 4 to prevent interference with the cupboard wall close to the first hinge 4, which could prevent the box door 2 from opening to a larger angle. When the box door 2 rotates to be closed, the slide mechanism drives the door panel 21 to slide a predetermined distance toward the first hinge 4 to prevent interference with the cupboard wall away from the first hinge 4, which could prevent the box door 2 from fully closing and affect the function of the box body 1. When the box door 2 is fully closed, the door panel 21 returns to a flush position with the cupboards. By designing a reasonable predetermined distance, the door panel 21 may avoid interference with the cupboard walls when sliding relative to the box door 2.

In another embodiment of the present application, the door body assembly and the box body 1 are provided within the cupboard. During the opening or closing of the box door 2, a slide mechanism is configured to drive the door panel 21 to move a predetermined distance on the box door 2, to avoid the box door 2 from the sidewalls of the cupboard.

In the present embodiment, the box body 1 is provided within a single cupboard. The material and color of the door panel 21 may be designed to be similar or identical to the outer walls of the cupboard. When the box door 2 is closed, the door panel 21 is flush with the outer walls of the cupboard, maintaining visual consistency and minimizing the gap between them, enhancing the appearance.

When the box door 2 rotates outward to be opened, the slide mechanism drives the door panel 21 to slide a predetermined distance away from the first hinge 4 to prevent interference with the cupboard wall close to the first hinge 4, which could prevent the box door 2 from opening to a larger angle. When the box door 2 rotates to be closed, the slide mechanism drives the door panel 21 to slide a predetermined distance toward the first hinge 4 to prevent interference with the cupboard wall away from the first hinge 4, which could prevent the box door 2 from fully closing and affect the function of the box body 1. When the box door 2 is fully closed, the door panel 21 returns to a flush position with the cupboards. By designing a reasonable predetermined distance, the door panel 21 may avoid interference with the cupboard walls when sliding relative to the box door 2.

In another embodiment of the present application, as shown in FIG. 1 and FIG. 2, a refrigeration apparatus is provided, including: a box body 1 and a door body assembly according to any of the above embodiments. The box body 1 is formed with a storage space, and the box door 2 is rotatably connected to the box body 1 for opening or closing the storage space.

In the present embodiment, the door body assembly includes: a box door 2, a door panel 21, and a slide mechanism. The slide mechanism, provided at the box door 2, is configured to drive the door panel 21 to move relative to the width direction of the box door 2 during the opening or closing process of the box door 2.

By providing a door panel 21 at the box door 2, when the refrigeration apparatus is embedded, provided within a recessed space, or provided between two cupboards, the door panel 21 may be flush with the cupboards on the side walls or sides of the recess, minimizing the gap between the refrigeration apparatus and the adjacent walls or cupboards, creating a more aesthetically pleasing design.

Simultaneously, as the box door 2 rotates, the slide mechanism may drive the door panel 21 to move relative to the box door 2 as far away from obstacles such as the wall or cupboards on the side of the box body 1 as possible during the rotation of the box door 2 to prevent these obstacles from blocking the door panel 21 and affecting the rotation of the box door 2, potentially preventing the box door 2 from opening or closing properly.

The combination of the box door 2 and the door panel 21 prevents the door panel 21 from interfering with surrounding objects during opening and closing, significantly improving user convenience. This design advantage is particularly evident in cramped kitchen environments. Furthermore, the slide mechanism ensures smooth movement of the door panel 21 during opening and closing, enhancing the lifespan and stability of the refrigerator.

Given that the door body assembly exhibits the beneficial effects of the above-described embodiments, the refrigeration apparatus also exhibits the beneficial effects of the above-described embodiments, which are not repeated herein.

In an embodiment, the box body 1 may have one or more storage spaces, each storage space corresponds to a corresponding door body assembly. A plurality of storage spaces may be provided in any manner, such as vertically, horizontally, or in a similar arrangement.

In some embodiments of the present application, as shown in FIG. 4, the box body 1 is formed with at least two storage spaces, and multiple door body assemblies are provided, each door body assembly corresponds to one of the storage spaces. When any box door 2 is opened or closed, the door panel 21 is driven to move relative to the corresponding box door 2.

In the present application, the box body 1 is provided with at least two storage spaces, and the two storage spaces may be configured to have different storage environments (different temperatures, humidity levels, etc.) to meet the storage requirements of different items. Each storage space is provided with a corresponding door body assembly, and the box door 2 of the corresponding door body assembly may open or close the corresponding storage space, allowing the two storage spaces to be opened or closed independently, making it convenient for users to store or retrieve items within the storage spaces. The door panel 21 of each door body assembly may also slide relative to the corresponding box door 2. When the box door 2 is closed, the door panel 21 may be flush with the adjacent cupboard, or when the box door 2 is opened, the door panel 21 may avoid obstacles on either side.

In an embodiment of the present application, as shown in FIG. 4, the box body 1 is provided with a first storage space and a second storage space. Accordingly, the door body assembly further includes a first door body assembly and a second door body assembly. The box door 2 of the first door body assembly is rotatably connected to the box body 1 to open or close the first storage space, and the box door 2 of the second door body assembly is rotatably connected to the box body 1 to open or close the second storage space.

Furthermore, the first door body assembly and the second door body assembly are provided vertically along a height direction of the box door 2. The first door body assembly further includes a first driven guide rail mechanism 8 and a second driven guide rail mechanism 9. The second door body assembly further includes a first driven guide rail mechanism 8 and a second driven guide rail mechanism 9. The slide mechanism and the first driven guide rail mechanism 8 of the first door body assembly are provided at a top of the corresponding box door 2, while the second driven guide rail mechanism 9 of the first door body assembly is provided at a bottom of the corresponding box door 2. The slide mechanism and the first driven guide rail mechanism 8 of the second door body assembly are provided at a bottom of the corresponding box door 2, while the second driven guide rail mechanism 9 of the first door body assembly is provided at a top of the corresponding box door 2.

Specifically, as shown in FIG. 4, the box body 1 is provided with a first connection hole 110, and the first hinge 4 is connected to the first connection hole 110 of the box body 1. The box body 1 is rotatably connected to the box door 2 of the first door body assembly through the first hinge 4.

The first storage space is separated from the second storage space through a first beam body 120. The first beam body 120 is provided with a second connection hole 121, and the first beam body 120 is connected to the second hinge 5 through the second connection hole 121. The second hinge 5 has two hinge shafts distributed in an up-and-down direction, and the two hinge shafts are rotatably connected to the box door 2 of the first door body assembly and the box door 2 of the second door body assembly, respectively.

A second beam body 130 is provided at a bottom of the second storage space. The second beam body 130 is provided with a third connection hole 132 and a fourth connection hole 131. The second beam body 130 is rotatably connected to the box door 2 of the second door body assembly through the third connection hole 132 and the third hinge 6. The second beam body 130 is connected to the slide mechanism of the second door body assembly through the fourth connection hole 131.

The top and bottom of the box door 2 of the first door body assembly are provided with a first end cover 210 and a second end cover 220, respectively. The first end cover 210 is rotatably connected to the first hinge 4, while the second end cover 220 is rotatably connected to a hinge shaft located above the second hinge 5 to rotate the box door 2 of the first door body assembly relative to the box body 1.

The top and bottom of the box door 2 of the second door body assembly are provided with a third end cover 310 and a fourth end cover 320, respectively. The fourth end cover 320 is rotatably connected to the third hinge 6, while the third end cover 310 is rotatably connected to a hinge shaft located below the second hinge 5 to rotate the box door 2 of the second door body assembly relative to the box body 1.

In an embodiment of the present application, as shown in FIG. 4 and FIG. 19, two ends of the first end cover 210 are provided with first hinge holes 211 rotatably connected to the first hinge 4 and the first end cover 210 may be connected to the first hinge 4 through the first hinge hole 211 at one end. The first end cover 210 is provided with a first mount slot 213, and the wall of the first mount slot 213 is provided with a first mounting hole 216. The slide mechanism is bolted to the wall of the first mount slot 213 through the first mounting hole 216. A wall of the first mount slot 213 facing the box body 1 is provided with a first avoidance opening 214 corresponding to the traction mechanism. The traction mechanism is movably inserted into the first avoidance opening 214 to pull the slide mechanism with the movement of the box door 2.

The first end cover 210 is further provided with a third mount slot 212 in which the first driven guide rail mechanism 8 is mounted. The positions of the slide mechanism and the first driven guide rail mechanism 8 may be interchanged depending on the hinge position of the box door 2 and the box body 1. Accordingly, a wall of the third mount slot 212 facing the box body 1 is provided with a second avoidance opening 215 for avoiding the traction mechanism.

Specifically, opposing side walls of the first mount slot 213 and third mount slot 212 are provided with a third recess218 and a fourth recess 219 as well as a first protrusion ridge 217 for insertion to be inserted and fixed with the first primary decorative cover 13 or the first secondary decorative cover 17.

Specifically, as shown in FIG. 23 and FIG. 24, two side surfaces of the first primary decorative cover 13 are provided with the first notch 1303 and the second notch 1304 corresponding to the first mount slot 213 and the third mount slot 212, respectively to allow the slide mechanism and the first driven guide rail mechanism 8 to extend beyond the notches and be connected to the door panel 21. Two ends of the first primary decorative cover 13 are provided with a fourth notch 1302 and a fifth notch 1301 to allow the traction mechanism to swing with the movement of the box door 2 when the slide mechanism is mounted in the first mount slot 213 or the third mount slot 212. The first primary decorative cover 1 is provided with a first snap slot 1305 corresponding to the first protrusion ridge 217, an inner side of the first notch 1303 is provided with a first protrusion rib 1307 snapped to a wall of the first mount slot 213 and an inner side of the second notch 1304 is provided with a second protrusion rib 1306 snapped to a wall of the second mount slot 212.

Correspondingly, the first secondary decorative cover 17 has a similar structure to the first primary decorative cover 13 except notches through which the slide mechanism and the first driven guide rail mechanism 8 extend. These details are not repeated here.

As shown in FIG. 20, an inner wall of the second mount slot of the second end cover 220 is provided with a third mounting hole 224, and the first guide rail fixation base 221 is mounted within the second mount slot through the third mounting hole 224. The first guide rail fixation base 221 is provided with a second mounting hole 223, and the second driven guide rail mechanism 9 is provided at the first guide rail fixation base 221 through the second mounting hole 223.

Specifically, opposing side walls of the second mount slot are provided with a second protrusion ridge 225 and a third protrusion ridge 227 for insertion to be inserted and fixed with the second primary decorative cover 14 or the first secondary decorative cover 17.

In an embodiment of the present application, as shown in FIG. 13, FIG. 14, FIG. 26, and FIG. 27, there are two third connection blocks 905, the second primary decorative cover 14 is provided with two third notches 1401 corresponding to the two third connection blocks 905 of the second driven guide rail mechanism 9, and the second primary decorative cover 14 is also formed with a chamber covered by the second end cover 220. Two ends of the chamber are provided with a fourth protrusion ridges 1403 and a fifth protrusion ridge 1408, and a bottom of the chamber is provided with a sixth protrusion ridges 1404 and a seventh protrusion ridge 1407 to be assembled with the third protrusion ridge 227 at the second end cover 220 together. Furthermore, the bottom of the chamber is further provided with a second snap slot 1405 and a third snap slot 1406 matched with and snapped to the second protrusion ridge 225 each other to assemble the second end cover 220 and the second primary decorative cover 14 together.

As shown in FIG. 4, FIG. 17, and FIG. 18, the top and bottom of the box door 2 of the second door body assembly are provided with the third end cover 310 and the fourth end cover 320, respectively. The fourth end cover 320 is rotatably connected to the third hinge 6, while the third end cover 310 is rotatably connected to a hinge shaft located below the second hinge 5 to rotate the box door 2 of the second door body assembly relative to the box body 1.

As shown in FIG. 4, FIG. 21, and FIG. 22, the second door body assembly further includes a third primary decorative cover 15, a fourth primary decorative cover 16, a third secondary decorative cover 19, and a fourth secondary decorative cover 20.

The third primary decorative cover 15 and the third secondary decorative cover 19 are detachably mounted to the third end cover 310 at the top of the second door body assembly. The third primary decorative cover 15 has a similar structure to the second primary decorative cover 14 and the third secondary decorative cover 19 has a similar structure to the second secondary decorative cover 18.

The fourth primary decorative cover 16 and the fourth secondary decorative cover 20 are detachably mounted to the fourth end cover 320 at the bottom of the second door body assembly. The fourth primary decorative cover 16 has a similar structure to the fourth primary decorative cover 13 and the fourth secondary decorative cover 20 has a similar structure to the first secondary decorative cover 17.

Specifically, when the door panel 21 of the second door body assembly is to be installed, the third primary decorative cover 15 and the fourth primary decorative cover 16 may be mounted at the third end cover 310 and the fourth end cover 320, respectively. When no door panel 21 is required, the third primary decorative cover 15 and the fourth primary decorative cover 16 may be removed, and the third secondary decorative cover 19 and the fourth primary decorative cover 16 may be mounted at the third end cover 310 and the fourth end cover 320, respectively.

As shown in FIG. 29, two ends of the third end cover 310 are provided with second hinge holes 314 rotatably connected to the second hinge 5 and a side of the third end cover 310 facing away from the box door 2 is provided with the hand grip slot 316. The third end cover 310 is provided with a fourth mount slot into which the second guide rail fixation base 311 is mounted. The second guide rail fixation base 311 is provided with a fourth mounting hole 315 through which the second driven guide rail mechanism 9 of the second door body assembly is mounted at the second guide rail fixation base 311. A top surface of the third end cover 310 is provided with a plurality of eighth protrusion ridges 313 inserted with the third primary decorative cover 15 and the third secondary decorative cover 19.

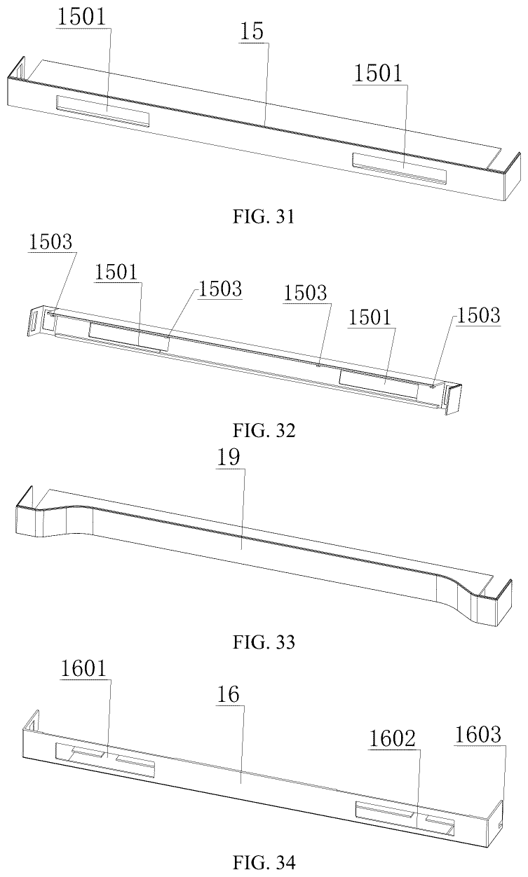

As shown in FIG. 31 and FIG. 32, the third primary decorative cover 15 is provided with two sixth notches 1501 corresponding to the second driven guide rail mechanism 9 and the third primary decorative cover 15 is further provided with a plurality of fourth snap slots 1503 corresponding to the eighth protrusion ridges 313. When the third primary decorative cover 15 is snapped to the third end cover 310, the hand grip slot 316 of the third end cover 310 is exposed outside, making it convenient for the user to insert their hand into the hand grip slot 316 to open and close the box door 2. The second driven guide rail mechanism 9 may be connected to the door panel 21 through the sixth notches 1501.

As shown in FIG. 33, the third secondary decorative cover 19 has a similar structure to the third primary decorative cover 15, except the notch structure for the second driven guide rail mechanism 9 to penetrate through.

As shown in FIG. 30, the fourth end cover 320 is provided with a fifth mount slot 323 and a wall of the fifth mount slot 323 is provided with a fifth mounting hole 325. The slide mechanism is bolted to the fifth mount slot 323 through the fifth mounting hole 325. A wall of the fifth mount slot 323 facing the box body 1 is provided with a third avoidance opening 322 corresponding to the traction mechanism. The traction mechanism is movably inserted into the third avoidance opening 322 to pull the slide mechanism with the movement of the box door 2.

The fourth end cover 320 is further provided with a sixth mount slot 324 in which the second driven guide rail mechanism 9 is mounted. The positions of the slide mechanism and the first driven guide rail mechanism 8 may be interchanged depending on the hinge position of the box door 2 and the box body 1. Accordingly, a wall of the sixth mount slot 324 facing the box body 1 is provided with a fourth avoidance opening 321 for avoiding the traction mechanism. The fourth end cover 320 is provided with a ninth protrusion ridge 327 matched with and snapped to the fourth primary decorative cover 16 and the fourth secondary decorative cover 20.

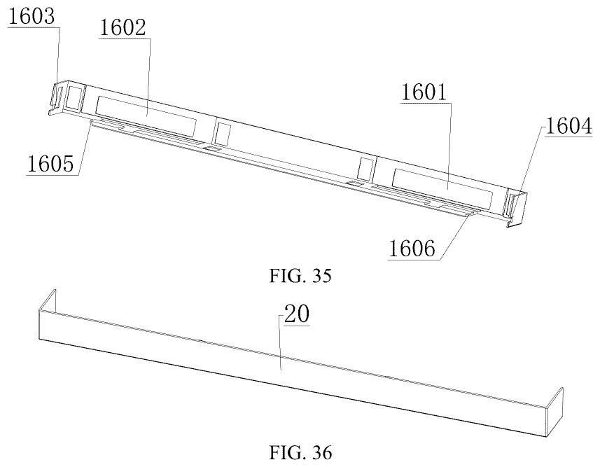

Accordingly, as shown in FIG. 34 and FIG. 35, two side surfaces of the fourth primary decorative cover 16 are provided with a seventh notch 1601 and an eight notch 1602 corresponding to the fifth mount slot 323 and the sixth mount slot 324, respectively, to allow the slide mechanism and the first driven guide rail mechanism 8 to extend beyond the notches and be connected to the door panel 21. Two ends of the fourth primary decorative cover 16 are provided with a ninth notch 1604 and a tenth notch 1603 to allow the traction mechanism to swing with the movement of the box door 2 when the slide mechanism is mounted in the fifth mount slot 323 or the sixth mount slot 324. The fourth primary decorative cover 16 is provided with a fifth snap slot 1606 and a sixth snap slot 1605 corresponding to the ninth protrusion ridge 327.

As shown in FIG. 36, the fourth secondary decorative cover 20 has a similar structure to the fourth primary decorative cover 16, except the notch structure for the slide mechanism and the first driven guide rail mechanism 8 to penetrate through.

Finally, it should be noted that the above embodiments are only used to illustrate the present application, but not to limit the present application. Although the application has been described in detail with reference to the embodiments, those skilled in the art should understand that various combinations, modifications, or equivalent replacements of the solutions of the application do not depart from the scope of the solutions of the application, and should all be covered in the scope of the claims of the present application.

1. A side-by-side door body assembly for an embedded refrigeration apparatus, comprising:
a side-by-side box door comprising two box doors provided in a pair, wherein the box doors are rotatably connected to a refrigeration box body, the refrigeration box body being embedded into an accommodation space formed by a mount body;
a side-by-side door panel comprising two door panels provided in a pair, wherein the door panels are movably mounted to the box doors and are movable along a width direction of the box doors, the door panels being configured for moving toward a door-opening side during opening of the side-by-side box door;
wherein each of the door panels has a first interference position and a second interference position, the first interference position being located at an inner corner of the door panel on a door-opening side, the second interference position being located at an outer corner of the door panel on a hinge side;
wherein when the side-by-side box door is in a closed position, a gap between end surfaces of the two door panels on the door-opening side is δ, a distance between end surfaces of the door panels on the hinge side and a sidewall of the corresponding accommodation space being δ′; and
wherein δ is greater than a movement distance γ along a width direction of the accommodation space before the first interference position moves away from the accommodation space, δ′ being greater than a movement distance λ along the width direction of the accommodation space before the second interference position moves away from the accommodation space.

2. The side-by-side door body assembly of claim 1, wherein the side-by-side box door comprises a first box door and a second box door, both of the first box door and the second box door being rotatably connected to the refrigeration box body, the side-by-side door panel comprising a first door panel and a second door panel, the first door panel being movably mounted to the first box door, the second door panel being movably mounted to the second box door;
wherein a movement distance along a width direction of the accommodation space before a first interference position of the first door panel moves away from the accommodation space is γ1, and wherein a movement distance along the width direction of the accommodation space before a first interference position of the second door panel moves away from the accommodation space is γ2,
the first box door and the second box door being opened simultaneously, with γ1+γ2≤δ, or
one of the first box door or the second box door being opened, with γ1≤δ and γ2≤δ.

3. The side-by-side door body assembly of claim 2, wherein a movement distance along a width direction of the accommodation space before a second interference position of the first door panel moves away from the accommodation space is λ1, and a movement distance along the width direction of the accommodation space before a second interference position of the second door panel moves away from the accommodation space is λ2;
wherein a distance between an end surface of the first door panel on a hinge side and a sidewall of the corresponding accommodation space is δ3, and a distance between an end surface of the second door panel on a hinge side and a sidewall of the corresponding accommodation space is δ4;
$$λ 1 \leq δ 3 ; λ 2 \leq δ 4 .$$

4. The side-by-side door body assembly of claim 3, wherein δ is positively correlated with l1, l3, h1, l4, l5, h2, a maximum Δs1 before the first interference position of the first door panel moves away from the accommodation space, and a maximum Δs2 before the first interference position of the second door panel moves away from the accommodation space;
wherein l1 is a vertical distance from a hinge shaft center of the first box door to an inner surface of the first door panel, l3 is a vertical distance from the hinge shaft center of the first box door to the end surface of the first door panel on a hinge side, h1 is a thickness of the first door panel, Δs1 is a distance that the first door panel moves relative to the first box door during opening of the first box door;
wherein l4 is a vertical distance from a hinge shaft center of the second box door to an inner surface of the second door panel, l5 is a vertical distance from the hinge shaft center of the second box door to the end surface of the second door panel on a hinge side, h2 is a thickness of the second box door, Δs2 is a distance that the second door panel moves relative to the second box door during opening of the second box door.

5. The side-by-side door body assembly of claim 4, wherein δ3 is positively correlated with l1, l3, and h1, and negatively correlated with a maximum Δs1 before the first interference position of the first door panel moves away from the accommodation space;
wherein δ4 is positively correlated with l4, l5, and h2, and negatively correlated with a maximum Δs2 before the first interference position of the second door panel moves away from the accommodation space.

6. The side-by-side door body assembly of claim 5,
$$wherein δ 3 \geq λ 1 = b 1 * cos β 1 - l 3 ,$$
$$wherein b 1 = \sqrt{{( l 1 + h 1 )}^{2} + {( l 3 - Δ s 1 )}^{2}} ,$$
$$β1 = 9 {0}^{∘} - [ arctan ( \frac{l 3 - Δ s 1}{l 1 + h 1} ) + Δθ1 ] ;$$
$$δ4 \geq λ 2 = b 2 * cos β2 - l 5 ,$$
$$wherein b 2 = \sqrt{{( l 4 + h 2 )}^{2} + {( l 5 - Δ s 2 )}^{2}} ,$$
$$β 2 = 90 ° - [ arctan ( \frac{l 5 - Δ s 2}{l 4 + h 2} ) + Δθ2 ] ;$$
$$δ \geq γ1 + γ 2 = a 1 * cos α1 - l 2 + a 2 * cos α2 - l 6 , or$$
$$δ \geq γ1 = a 1 * cos α1 - l 2 , and , δ \geq γ 2 = a 2 * cos α2 - l 6 ,$$
$$wherein a 1 = \sqrt{l {1}^{2} + {( l 2 + Δ s 1 )}^{2}} , α 1 = 9 {0}^{∘} - [ arctan ( \frac{l 2 + Δ s 1}{l 1} ) - Δ θ 1 ] ,$$
$$a 2 = \sqrt{l {4}^{2} + {( l 6 + Δ s 2 )}^{2}} , α 2 = 9 {0}^{∘} - [ arctan ( \frac{l 6 + Δ s 2}{l 4} ) - Δθ2 ] ;$$
wherein Δθ1 is an opening angle of the first box door, Δs1 is a distance that the first door panel moves relative to the door-opening side of the first box door during the opening of the first box door, l1 is the vertical distance from the hinge shaft center of the first box door to the inner surface of the first door panel, l2 is a vertical distance from the hinge shaft center of the first box door to an end surface of the first door panel on a door-opening side, l3 is the vertical distance from the hinge shaft center of the first box door to the end surface of the first door panel on a hinge side, h1 is the thickness of the first door panel, a1 is a length of a side where the first interference position and the hinge shaft center of the first box door are located, α1 is an angle between the side where the first interference position and the hinge shaft center of the first box door are located and a horizontal line, b1 is a length of a side where the second interference position and the hinge shaft center of the first box door are located, and β1 is an angle between the side where the second interference position and the hinge shaft center of the first box door are located and the horizontal line;
wherein Δθ2 is an opening angle of the second box door, Δs2 is a distance that the second door panel moves relative to the door-opening side of the second box door during the opening of the second box door, l4 is the vertical distance from the hinge shaft center of the second box door to the inner surface of the second door panel, l6 is a vertical distance from the hinge shaft center of the second box door to an end surface of the second door panel on a door-opening side, l5 is the vertical distance from the hinge shaft center of the second box door to the end surface of the second door panel on the hinge side, h2 is the thickness of the second door panel, a2 is a length of a side where the first interference position and the hinge shaft center of the second box door are located, α2 is an angle between the side where the first interference position and the hinge shaft center of the second box door are located and a horizontal line, b2 is a length of a side where the second interference position and the hinge shaft center of the second box door are located, and β2 is an angle between the side where the second interference position and the hinge shaft center of the second box door are located and the horizontal line.

7. The side-by-side door body assembly of claim 1, wherein the gap δ satisfies:
$$δ \leq {γ}_{max} ;$$
wherein γₘₐₓ is a value of γ in a case that λ is zero and Δθ is Δθ_{crit}, γ is a vertical distance that the first interference position moves toward the sidewall of the corresponding accommodation space, λ is a vertical distance that the second interference position moves toward the sidewall of the corresponding accommodation space, Δθ is an angle of rotation during opening of the box door, Δθ that the first interference position moves away from the accommodation space is Δθ_{crit}, γ is positively correlated with Δs, and Δs is a distance that the door panel moves relative to the door-opening side of the door during opening.

8. The side-by-side door body assembly of claim 7, wherein the distance δ′ satisfies:
$${δ}^{′} \leq {λ}_{max} ;$$
wherein λₘₐₓ is a value of λ in a case that γ is zero and Δθ is Δθ_{crit}, λ is negatively correlated with Δs, γ is a vertical distance that the first interference position moves toward the sidewall of the corresponding accommodation space, λ is a vertical distance that the second interference position moves toward the sidewall of the corresponding accommodation space, Δθ is an angle of rotation during opening of the box door, Δθ that the first interference position moves away from the accommodation space is Δθ_{crit}, γ is positively correlated with Δs, Δs is a distance that the door panel moves relative to the door-opening side of the door during opening.

9. The side-by-side door body assembly of claim 1, wherein a hinge shaft center is a movable shaft.

10. The side-by-side door body assembly of claim 4, wherein l1 is 5 mm to 50 mm, l2 is 240 mm to 700 mm, l3 is (300 mm to 700 mm) minus l2, h1 is 10 mm to 25 mm, and δ3 is 0.5 mm to 5 mm;
l4 is 5 mm to 50 mm, l5 is 240 mm to 700 mm, l6 is (300 mm to 700 mm) minus 15, h2 is 10 mm to 25 mm, and δ4 is 0.5 mm to 5 mm.

11. The side-by-side door body assembly of claim 10, wherein l1 is 5 mm to 50 mm, l2 is 240 mm to 700 mm, l3 is (300 mm to 700 mm) minus l2, l4 is 5 mm to 50 mm, l5 is 240 mm to 700 mm, l6 is (300 mm to 700 mm) minus 15, h2 is 10 mm to 25 mm, and δ is 1 mm to 10 mm.

12. An embedded refrigeration apparatus, comprising:
a refrigeration box body embedded in an accommodation space; and
the side-by-side door body assembly for the embedded refrigeration apparatus of claim 1.
